(19) United States
(12) Patent Application Publication
(10) Pub. No.: US 2026/0193865 A1
(43) Pub. Date: Jul. 9, 2026

(54) HEAVY EQUIPMENT MONITORING AND DETERMINATION OF EQUIPMENT UTILIZATION AND PRODUCTIVITY AND ESTIMATED EMISSIONS OUTPUT

(71) Applicant: Tenderd Inc., San Diego, CA (US)

(72) Inventor: Arjun Mohan, San Diego, CA (US)

(21) Appl. No.: 19/439,255

(22) Filed: Jan. 2, 2026

Related U.S. Application Data
(60) Provisional application No. 63/741,723, filed on Jan. 3, 2025.
(60) Provisional application No. 63/741,725, filed on Jan. 3, 2025.

(51) Int. Cl. E02F 9/20; G06V 20/50

(52) U.S. Cl. CPC E02F 9/2054; G06V 20/50

(57) ABSTRACT

Systems and methods provide for heavy equipment monitoring and utilization and productivity determination. Data collection devices are installed onto multiple pieces of equipment to be monitored. The data collection devices receive sensor data and equipment information data during the course of operations of the equipment. The data collection devices each transmit the collected data to a server or service that accumulates the collected data. The server or service evaluates the data and determines utilization and productivity of each of the multiple pieces of equipment. The system generates a user interface describing identifying information about a particular piece of equipment and an associated utilization rate, productivity rate and/or an emission output amount of the particular equipment over a time period.

### CROSS-REFERENCE TO RELATED APPLICATIONS

The application claims priority to U.S. provisional application 63/741,723 filed on Jan. 3, 2025, and U.S. provisional application 63/741,725 filed on Jan. 3, 2025, both of which are hereby incorporated by reference in their entirety.

### FIELD

This patent application relates generally to monitoring operational status of heavy equipment, and more particularly, to systems and methods for heavy equipment usage monitoring, utilization determination, and estimated emissions output determination. This patent application also relates generally to monitoring operational status of heavy equipment, and more particularly, to systems and methods for heavy equipment usage monitoring and estimated emissions output determination.

### SUMMARY

In some embodiments, systems and methods provide for heavy equipment monitoring and utilization determination. Heavy equipment includes, for example, stationary equipment and mobile equipment. A system and method of monitoring and determining equipment utilization, productivity utilization and equipment emissions output is described herein. The system includes the installation of data collection devices onto multiple pieces of equipment to be monitored. The data collection devices receive sensor data and equipment information data during the course of operations of the equipment. The data collection devices each transmit the collected data to a server or service that accumulates the collected data. The server or service evaluates the data and determines utilization of each of the multiple pieces of equipment. The system generates a user interface describing identifying information about a particular piece of equipment and an associated utilization rate, productivity rate and/or an emission output amount of the particular equipment over a time period.

In some embodiments, the system assigns a respective equipment type for each of the multiple pieces of equipment. The system receives sensors readings for each of the multiple pieces of equipment from one or more sensors installed on each piece of equipment. The system determines based on the equipment type, the received equipment operation information and the received sensor readings, a utilization and productivity indication for each of the multiple pieces of equipment. The system provides for display, via a user interface, depicting the utilization indication and productivity indication for each of the multiple pieces of equipment. The utilization indication describes the amount of idle time when the equipment is power on (such as an engine of the equipment running) and utilization time of the equipment. The productivity indication describes the amount of time when the piece of equipment is performing sometime of measured work. The displayed user interface includes at least two pieces of equipment that are of two different equipment types. The system determines and displays a utilization rate or percentage and/or a productivity rate or percentage of the equipment.

In some embodiments, the system receives pressure readings for each of the plurality of vehicles from one or more pressure sensors attached to each of the plurality of vehicles. The system determines based on the vehicle type and the received vehicle operation information and the received pressure readings, a utilization indication for each of the plurality of vehicles. The system provides for display, via a user interface, the utilization indication for each of the plurality of vehicles, the utilization indicating an amount of idle time and utilization time. The displayed user interface includes at least two vehicles that have been two different vehicle types. The system determines emissions output of vehicle based on an emissions fingerprint and RPM operational values of a vehicle.

In some embodiments, systems and methods provide for determination of equipment emissions output. Emissions fingerprints are obtained for the exhaust emissions of the equipment. Exhaust gas readings are obtained while the equipment engines are operating. The emission fingerprints include values for emissions output at various RPM (i.e., revolutions/minute) operating levels of the engines of the equipment. Engine operations of the equipment is monitored, and RPM values of the engine are sent to a server for determination of the emissions output. In some embodiments, actual usage fuel values are also sent to a server for use in determination of the emissions output. The server performs operations to determine estimated emissions output. Based on an emissions fingerprint, the system uses the received RPM operational data for a respective piece of equipment to determine an estimated emissions output for a time period. The system generates a graph depicting an emissions output of the respective piece of equipment for the time period.

The appended claims may serve as a summary of this application.

### BRIEF DESCRIPTION OF THE DRAWINGS

FIG. 1A is a diagram illustrating an exemplary system in which some embodiments may operate.

FIG. 1B is a diagram illustrating an exemplary computer system with software and/or hardware modules that may execute some of the functionality described herein.

FIG. 1C is a diagram illustrating an exemplary computer system with software and/or hardware modules that may execute some of the functionality described herein.

FIG. 2 is a flow chart illustrating an exemplary method that may be performed in some embodiments.

FIG. 3A-3B is a diagram illustrating different exemplary heavy equipment.

FIG. 4 is a diagram illustrating an excavator loading a dump truck.

FIG. 5 is a diagram illustrating exemplary bulldozer performing field operations.

FIG. 6 is a diagram illustrating an exemplary user interface.

FIG. 7 is a diagram illustrating an exemplary user interface.

FIG. 8 is a flow chart illustrating an exemplary method that may be performed in some embodiments.

FIG. 9 is a diagram illustrating a vehicle performing repetitive operations.

FIG. 10 is a diagram illustrating generators and welding machines.

FIG. 11 is a flow chart illustrating an exemplary method that may be performed in some embodiments.

FIG. 12 is a diagram illustrating a chart of measured emissions output for two different vehicles with the same engine make and model.

FIG. 13 is a diagram illustrating an exemplary user interface.

FIG. 14 is a diagram illustrating an exemplary user interface.

FIG. 15 is a diagram illustrating an exemplary computer that may perform processing in some embodiments.

FIG. 16 is a diagram illustrating exemplary equations as to some embodiments related to machine learning for emissions determination.

FIG. 17 is a diagram illustrating exemplary equations as to some embodiments related to machine learning for emissions determination.

FIG. 18 is a diagram illustrating exemplary equations as to some embodiments related to machine learning for emissions determination.

FIG. 19 is a diagram illustrating exemplary equations as to some embodiments related to machine learning for emissions determination.

FIG. 20 is a diagram illustrating exemplary equations as to some embodiments related to machine learning for emissions determination.

FIG. 21 is a diagram illustrating exemplary equations as to some embodiments related to machine learning for emissions determination.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

### Data Collection and Sensor Monitoring of Vehicles and Equipment

In some embodiments, each vehicle being monitored has installed onto the vehicle a data collections and communication system or module, referred to as the data collection device. The data collection device includes a telecommunications subsystem that allows the data collection device to transmit and receive data to/from other devices, such mobile devices or computer servers. The data collection device, for example, may include wireless transceivers, such a LTE, 4G, or 5G transceivers, WIFI routers or modems, LoRa transceivers, satellite transceivers or other known technology allowing for the transmission of data to another computing device.

The data collection device has one or more onboard processers that are configured to receive or collect data directly from a vehicle's CAN bus, electronic control unit (ECU), or other telematics system of the vehicle. Additionally, the data collection device is configured to receive data directly from one or more sensors installed on the vehicle. Examples of the sensors that may be installed on the vehicle are any one or more of the following: pressure sensors, load sensors, proximity sensors, and/or digital cameras. Furthermore, the data collection device may include a location positioning system, such as GPS, GLONASS, Galileo system to identify vehicle positioning, trajectory and course of travel.

Many of the vehicles being monitored include hydraulic systems for moving or positioning components of the vehicle to perform operations on terrain, earth, dirt, rocks, etc. Examples of these vehicles include heavy equipment such as a bulldozer, excavator, power shovel, backhoe, tractor, scraper, dump truck, articulated dump truck, compactor, forklift, piling rigs, etc. One or more wired or wireless pressure sensors may be attached to operative hydraulic lines of a vehicle. The attached pressure sensor monitors hydraulic pressure during hydraulic operations of the vehicle. For example, a pressure sensor may be attached to an auxiliary hydraulic port or may be installed in line of the operative hydraulic line. During hydraulic operations of a vehicle, the installed one or more pressure sensors monitor and transmit hydraulic pressure readings to the data collection device. The data collection device stores the received hydraulic pressure readings and associates a date/time stamp of the received hydraulic pressure readings.

A few examples of hydraulic pressure readings as to two different types of heavy equipment are illustrative of how the hydraulic pressures of a vehicle are monitored. In an example of monitoring hydraulic operations of a bulldozer, one or more pressure sensors may be installed on the bulldozer to obtain hydraulic pressure readings of the actuation of the bulldozer's blade. The bulldozer includes a hydraulic system with arms and pistons interconnected to the bulldozer bade. When the bulldozer blade is moved up/down or the blade angled, the installed one or more pressure sensors monitor the hydraulic pressures during those operations. The installed pressure sensors transmit the pressure readings to the data collection device.

In an example of monitoring hydraulic operations of a power shovel, one or more pressure sensors may be installed on the power shovel to obtain hydraulic pressure readings of the actuation of the power shovel's crane and bucket. The power shovel includes a hydraulic system with a crane, bucket with interconnected arms and pistons. When the bucket and/or crane is moved up/down or the bucket angled, the installed one or more pressure sensors monitor the hydraulic pressures during those operations. The installed pressure sensors transmit the pressure readings to the data collection device.

In an example of monitoring hydraulic operations of a dump truck, one or more pressure sensors may be installed on the dump truck to obtain hydraulic pressure readings of the actuation of the dump truck's dump body (also referred to as a dump box). The dump truck includes a hydraulic system with a dump body with interconnected arms and pistons. When the dump body is moved (such as tilting the dump body up/down), the installed one or more pressure sensors monitor the hydraulic pressures during those operations. The installed pressure sensors transmit the pressure readings to the data collection device. In some examples, there are 3 different dump trucks: (1) a dump truck leaf spring suspension where a mechanical load sensor is installed to identify when a load moved; (2) a dump truck with air suspension where a pressure load sensor is installed to identify when a load moved; and (3) an articulated Dump truck where a proximity sensor is used to record tipping activity of the truck and then multiplying number of tips with average load value to calculate load moved.

In some embodiments, the data collection device performs pre-processing on the data received from the sensors installed on a piece of equipment. For example, the data collection device may be configured to summarize, or aggregate received sensor data values.

In some embodiments, the data collection device includes an image processing module that evaluates images received by the installed one or more cameras. In some embodiments, the image processing module is configured to identify objects in a received image. For example, the data collection device may process a received image and input the received image into a machine learning model to classify or identify one or more objects in the image.

The system generates one or more user interfaces to configure a vehicle for utilization assessment. An equipment identifier may be entered in the user interface to identify a particular piece of equipment. A type of equipment may be selected for the equipment. Examples of types of equipment that may be selected include any one of the following: Dump truck, Articulated dump truck, Excavator attachment, Excavator crawler, Excavator long boom, Excavator wheel, Excavator crawler jackhammer, Bulldozer, Compactor, Wheel loader shovel, Piling rigs rotary, Piling rigs red, Flatbed, Man lift, Forklift, Ride on roller, Boom truck, Truck mounted crane, Motor grader, Hiab crane. The foregoing listing is meant to be illustrative and other equipment types may be assigned to a particular piece of equipment.

In some embodiments, the equipment identifier of a piece of equipment is added or configured on the data collection device 100 for a particular vehicle. When the data collection device transmits data to the system services, the equipment identifier is transmitted with the collected sensor data. In some embodiments, the data collection device 100 installed on a piece of equipment has a unique identifier. The system stores, in a data store and/or memory, an association of each data collection device 100 identifier and an equipment identifier for the particular piece of equipment where the data collection device is installed. When the data collection device transmits data to the server or system services, the data collection device 100 identifier is transmitted with the collected sensor data. The system matches then is able to identify the respective received data receive from multiple data collection devices and match the received data for utilization and productivity determination for a respective piece of equipment.

In some embodiments, the system determines utilization hours of a piece of equipment as an amount of time when an equipment is being utilized during its operational time (e.g. ignition on of a vehicle) which is determined on sensor values or operational parameters.

In some embodiments, the system evaluates the received sensor data and equipment operation data for different types of equipment. The system uses predefined rules or algorithms in association with a particular type of equipment to determine utilization and/or productivity of the equipment. In other words, each equipment type may an associated a utilization metric the system uses to determine the utilization of a particular piece of equipment. Also, each equipment type may have an associated productivity metric the system uses to determine the productivity of a particular piece of equipment. For example, different types of utilization metrics include: assessing movement, assessing hydraulics activated, assessing blade activated, assessing elevation activated, or assessing blade activated. The foregoing listing is meant to be illustrative and other utilization metrics is used or assigned to a particular piece of equipment.

A few examples of determining utilization of different types of vehicles are described with reference to Table 1 and Table 2 below.

TABLE 1

| Equipment identifier | Equipment Type |
|---|---|
| DT1 | Dump truck |
| EC1 | Excavator crawler |
| BD1 | Bulldozer |
| DT2 | Dump truck |
| EC2 | Excavator crawler |
| BD2 | Bulldozer |
| BD3 | Bulldozer |

TABLE 2

| | Equipment | Sensor type | Utilization | Sensor type | Productivity | |
|---|---|---|---|---|---|---|
| No. | Type | for utilization | Metric | for production | Metric | Remarks |
| 1 | Hiab | GPS | Movement | Analog input | PTO Activated | For Electrical |
| | crane/Truck | | | | Time | Drive - Analog |
| | mounted | | | | | Input is |
| | crane/Boom | | | | | connected to PTO |
| | truck | | | | | Solenoid System |
| | | | | | | For Mechanical |
| | | | | | | Drive. Additional |
| | | | | | | hydraulic |
| | | | | | | pressure sensor is |
| | | | | | | installed on PTO |
| | | | | | | Hydraulic line to |
| | | | | | | monitor PTO |
| | | | | | | Activation. |
| 2 | Mobile Fuel | GPS | Movement | Flowmeter | Fuel | Flowmeter along |
| | Tank | | | | Dispensed | with Capacitive |
| | | | | | | Level Sensor. |
| 3 | Bulldozer | Pressure | Blade | GPS | Distance | Electrical Drive |
| | | sensor/Reed | Activated | | Pushed | with Joystick - |
| | | switch | | | | Analog input is |
| | | | | | | connected to - |
| | | | | | | OEM |
| | | | | | | Transmission |
| | | | | | | Solenoid |
| | | | | | | (Forward and |
| | | | | | | Reverse) and |
| | | | | | | OEM Parking |
| | | | | | | Brake Solenoid. |
| | | | | | | Mechanical Drive |
| | | | | | | with control |
| | | | | | | lever- Additional |
| | | | | | | hydraulic |
| | | | | | | Pressure sensor is |
| | | | | | | connected to the |
| | | | | | | transmission |
| | | | | | | control valve. |
| | | | | | | Additional Reed |
| | | | | | | Switch is |
| | | | | | | connected to the |
| | | | | | | OEM mechanical |
| | | | | | | control lever. |
| 4 | Flatbed/ | GPS | Movement | GPS | Distance | |
| | Trailer | | | | Traveled | |
| 5 | Dump truck - | GPS | Movement | Mechanical | Material | Proximity sensor |
| | Leaf | | | Axle Load | Moved | can also be used |
| | Spring | | | sensor | | to understand |
| | Suspension | | | | | tipping activity. |
| 6 | Dump truck - | GPS | Movement | Pressure | Material | Pneumatic |
| | Air | | | load Sensor | Moved | pressure load |
| | Suspension | | | | | sensor. |
| 7 | Forklift | Pressure sensor | Hydraulics | Pressure | Loads Carried | Additional |
| | | | Activated | sensor | | hydraulic |
| | | | | | | pressure sensor |
| | | | | | | and fittings are |
| | | | | | | connected to |
| | | | | | | hydraulic line. |
| 8 | Backhoe | Pressure sensor | Hydraulics | Pressure | Hydraulics | Analog |
| | | | Activated | sensor | Activated | connection to |
| | | | | | Time | OEM hydraulic |
| | | | | | | pressure sensor or |
| | | | | | | Additional |
| | | | | | | Hydraulic |
| | | | | | | pressure sensor |
| 9 | Dump truck - | GPS | Movement | Proximity | Material | |
| | articulated | | | sensor | Moved | |
| 10 | Crane | Pressure | Hydraulics | Vision | Weight Lifted, | Rotary encoder is |
| | (crawler, | sensor, Winch | Activated | | Hook/Unhook/ | installed on the |
| | mobile, | sensor | | | Loaded Time | Winch drum |
| | rough | | | | | (Main and |
| | terrain) | | | | | Auxiliary) |
| | | | | | | Analog |
| | | | | | | connection to |
| | | | | | | OEM hydraulic |
| | | | | | | pressure sensor. |
| | | | | | | Analog |
| | | | | | | connection to |
| | | | | | | Transducer |
| | | | | | | pressure sensor |
| | | | | | | on the derricking |
| | | | | | | cylinder. |
| | | | | | | Additional |
| | | | | | | Hydraulic |
| | | | | | | pressure sensor is |
| | | | | | | installed on PTO |
| | | | | | | Hydraulic line to |
| | | | | | | monitor PTO. |
| | | | | | | Activation |
| | | | | | | Camera is |
| | | | | | | installed on Hook |
| | | | | | | block. |
| 11 | Excavator | Pressure sensor | Hydraulics | Vision | Material | Analog |
| | crawler | | Activated | | Moved | connection to |
| | | | | | | OEM hydraulic |
| | | | | | | pressure sensor or |
| | | | | | | Additional |
| | | | | | | Hydraulic |
| | | | | | | pressure sensor |
| | | | | | | Additional |
| | | | | | | Camera is |
| | | | | | | installed above |
| | | | | | | the cabin |
| | | | | | | externally. |

Table 2 describes 30 different types of equipment that the system is configured to monitor and determine a utilization and/or productivity metric for the equipment. The system receives data from one or more sensors installed on a respective physical equipment. Based on the sensor data received by the system, the system determines utilization values and/or productivity values over a period of time for respective physical equipment. For each of the 30 different types of equipment, table 2 includes an example of a sensor type installed on the equipment and a metric used to determine utilization and/or determine productivity. Additional remarks describe aspects of the use and/or installation of a sensor on the particular type of equipment. Examples of different types of sensors installed a respective physical equipment include, but are not limited to, a pressure sensor (such as hydraulic or pneumatic), proximity sensor, load sensor, GPS sensor (geo-spatial location sensor), reed switch, camera (e.g., computer vision) and analog input sensor (to monitor current or voltage).

In some embodiments, the system provides for the configuration and assignment of vehicles to a vehicle type. Based on the vehicle type, a predefined utilization metric is used by the system to evaluate data received from a particular vehicle. In this example, a user of the system has defined six different vehicles that are to be monitored as to the vehicles. In this example the user has identified 6 vehicles and their respective equipment type. In this example, the user has defined two vehicles with an equipment type of “Dump Truck”, with equipment identifiers DT1, DT2. The user has defined one vehicle with an equipment type of “Excavator crawler”, with equipment identifier EC1. The user has defined three vehicles with an equipment type of “Bulldozer”, with vehicle identifies BD1, BD2, BD3.

Over a period of time, each of these defined vehicles will be operated in a field environment. Some of the vehicles may be operated each day for short or long intervals, and some of the vehicles may be operated periodically or intermittently over the period of time. Each of these vehicles has a data collection device installed on the vehicle to collect respective sensor data from the installed sensors. Additionally, the data collection device receives data from onboard vehicle systems, such as a CAN bus, ECU or other telematics system. The respective installed data collection devices transmit to the system servers the collected sensor data. The system servers then evaluate the received data and determine the utilization of a respective vehicle for a given time period.

In some embodiments, the system applies the metric of the equipment type from Table 2 that is associated with the assigned equipment type of Table 1. For example, in Table 1, the vehicle with an identifier of BD1 has been assigned to an equipment type of Bulldozer. In assessing the utilization of vehicle BD1, the system applies the predefined metrics or rules based on the assigned equipment type. In this example, the system will apply the Bulldozer utilization metric of “Blade Activated”

In some embodiments, the system determines a utilization rate for a vehicle based on an amount of time the vehicle was determined to be utilized (according to the metric for the particular type of vehicle divided by a total time that the vehicle engines was running (e.g., a total ignition time). A general formula to determine utilization rate=Utilization time/Total Engine time. The utilization rate may be depicted as a percentage value for a respective vehicle.

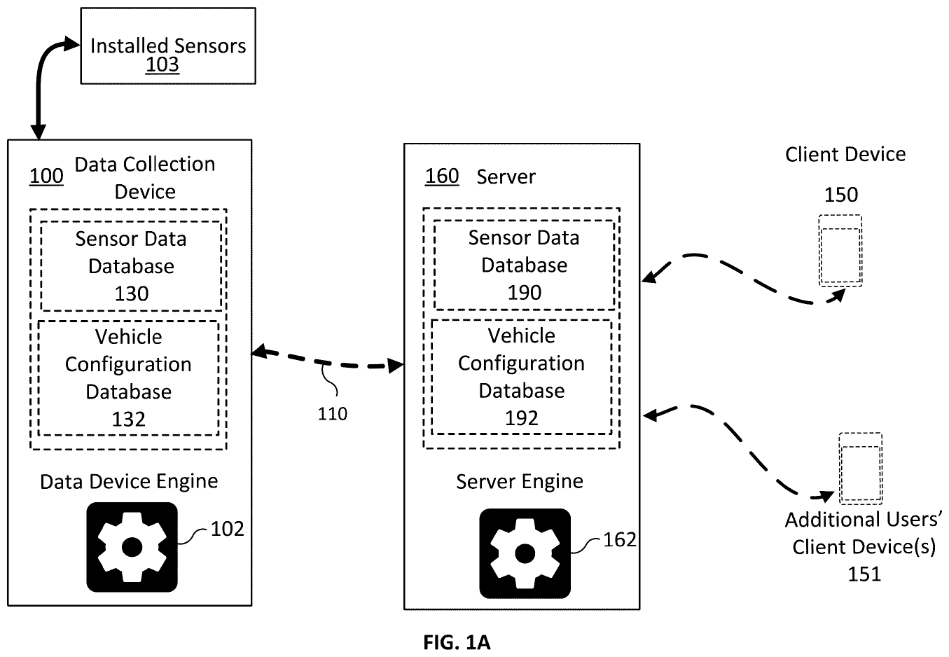

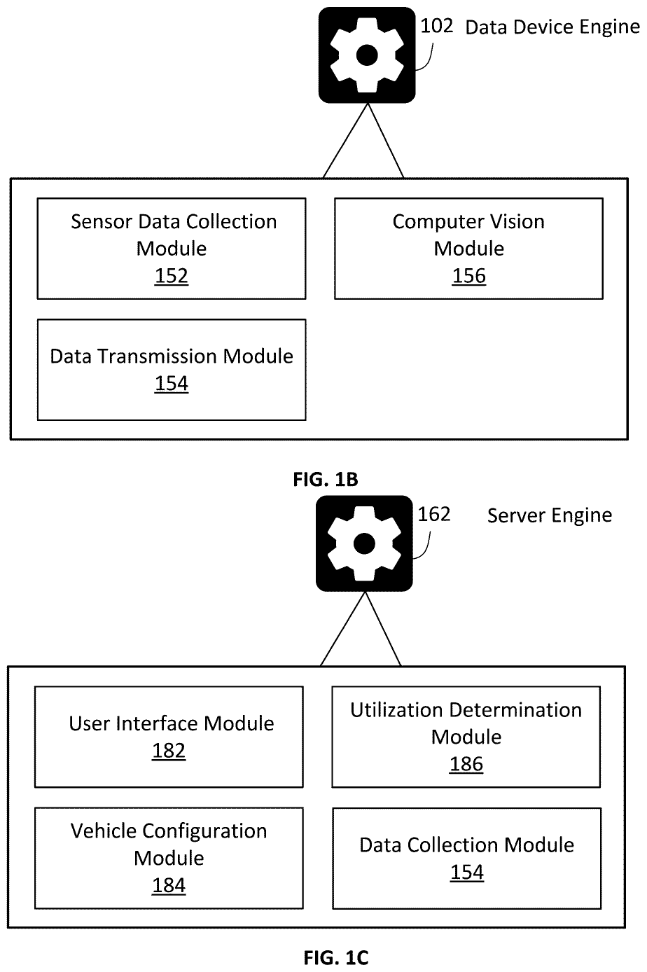

FIG. 1A is a diagram illustrating an exemplary system in which some embodiments may implemented. In the exemplary system, a first user's client device 150 and one or more additional users' client device(s) 151 are in communication with one or more servers 160 including a server engine 162. The first user's client device 150 communicates with the server 160 via communications link 111. The additional users' client devices 151 communicate with the server 160 via the multiple communication links 111n. The client devices 150, 151 may interact with one or more websites (e.g., web services) running a code or a service for interaction with the server engine 162.

The first user's client device 150 and additional users' client device(s) 151 may be devices with a display configured to present information to a user of the device. In some embodiments, the first user's client device 150 and additional users' client device(s) 151 present information in the form of a user interface (UI) with UI elements or components. In some embodiments, the first user's client device 150 and additional users' client device(s) 151 send and receive signals and/or information to the server engine 162.

In some embodiments, the first user's client device 150 and additional users' client device(s) 151 are computing devices capable of hosting and executing one or more applications or other programs capable of sending and/or receiving information. In some embodiments, the first user's client device 150 and/or additional users' client device(s) 151 may be a computer desktop or laptop, mobile phone, tablet, or any other suitable computing device capable of sending and receiving information.

The server engine 162 is connected to one or more repositories (e.g., non-transitory data storage) and/or databases, including a sensor data database 190 and a vehicle configuration database 192. The sensor database stores sensor data and vehicle information data received from one or more data collection devices 102.

The one or more servers 160 are in communication with respective, multiple data collection devices 100 that are installed on vehicles, such as heavy equipment. The respective data collections devices 100 are in communication with the server 160 via a respective communications link 110. A data collection device 100 includes a data device engine 102 that controls the operation of the data collection device. A data collection device 100 receives sensor data from one or more sensors installed on a particular vehicle. The data device engine 102 is connected to one or more repositories (e.g., non-transitory data storage) and/or database, including a sensor data database 130 and a vehicle configuration database 132. The data collection device 100 stores data received from installed sensors 103 and other received vehicle information in a sensor data database 103. Additional data collection devices receive data from their respective installed sensors.

In an embodiment, the data device engine 102, the server engine 162 and a client device 150, 151 may perform the method 200 other methods described herein and, as a result, provide for a system and method of monitoring heavy equipment operations and determining vehicle utilization.

FIG. 1B is a diagram illustrating an exemplary data collection device 100 (such as an edge computing device) with software and/or hardware modules that may execute some of the functionality described herein. The data collection device 100 may comprise, for example, a server or client device or a combination of server and client devices. The exemplary data collection device 100 is shown with the data device engine 102 performing or executing multiple modules: sensor data collection module 152, data transmission module 154, computer vision module 156.

The sensor data collection module 152 provides functionality for interacting with and collecting sensor data for sensors installed on a vehicle. The data transmission module 154 provides functionality for transmitting collected sensor data and vehicle information to server 160. The computer vision module 156 provides functionality for capturing images and/or video and evaluating the images to determine the occurrence of objects in the images.

FIG. 1C is a diagram illustrating an exemplary server 160 with software and/or hardware modules that may execute some of the functionality described herein. The server 160 may comprise, for example, a server or client device or a combination of server and client devices. The exemplary server 160 is shown with the server engine 162 performing multiple modules: user interface module 182, vehicle configuration module 184, utilization determination module 186 and data collection module 154.

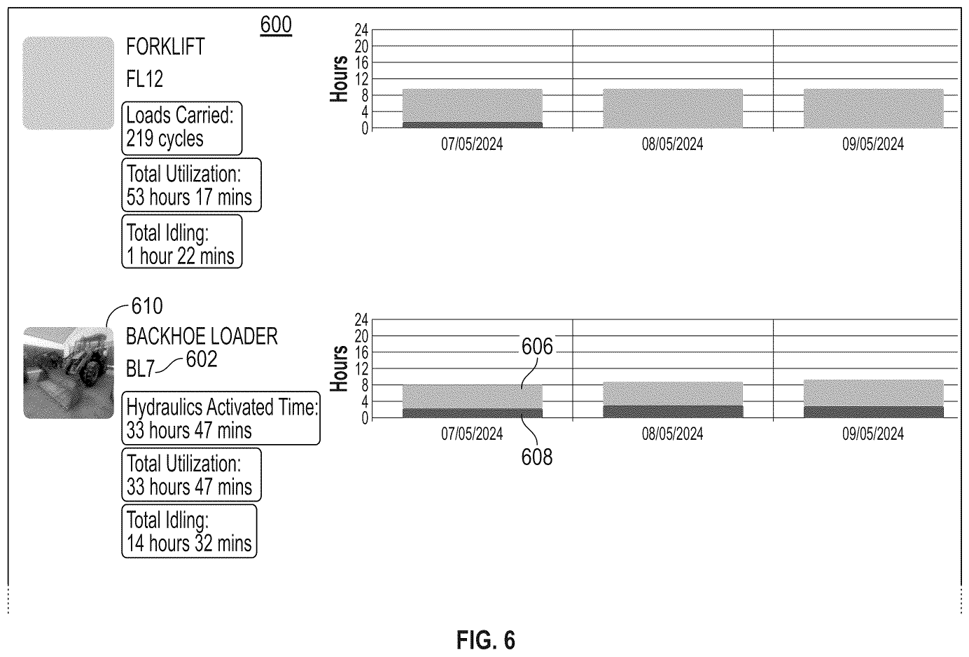

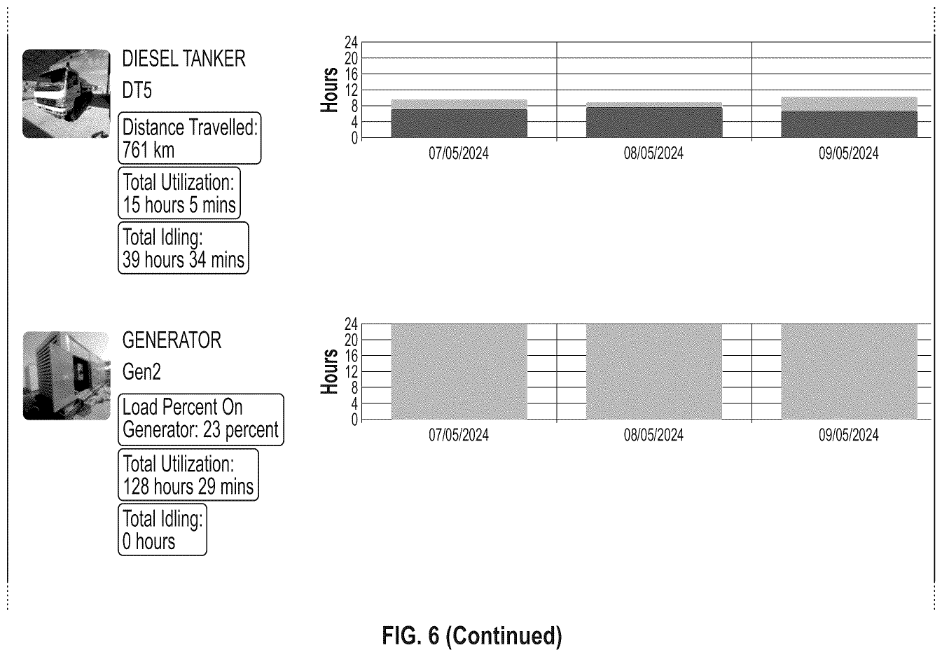

The user interface module 182 provides system functionality for presenting a user interface to the client devices 150, 151. Generated user interface receives and process user input from users. User inputs received by the user interface herein may include clicks, keyboard inputs, touch inputs, taps, swipes, gestures, voice commands, activation of interface controls, and other user inputs. The User Interface Module 182 generates the user interfaces of FIGS. 6,7 and 12. In some embodiments, the client devices have a user interface module that generates the user interface of FIGS. 6, 7 and 12. In other embodiments, the server and client devices are configured to generate the user interfaces of FIGS. 6, 7 and 12.

The vehicle configuration module 184 provides system functionality for configuring information about respective vehicles and assigning a particular vehicle a equipment identifier and a vehicle type. The metric determination module 186 provides system functionality for selecting a particular metric to be applied to a vehicle with a particular assigned vehicle type. The data collection module 154 provides system functionality for receiving data from the respective data collection devices 102.

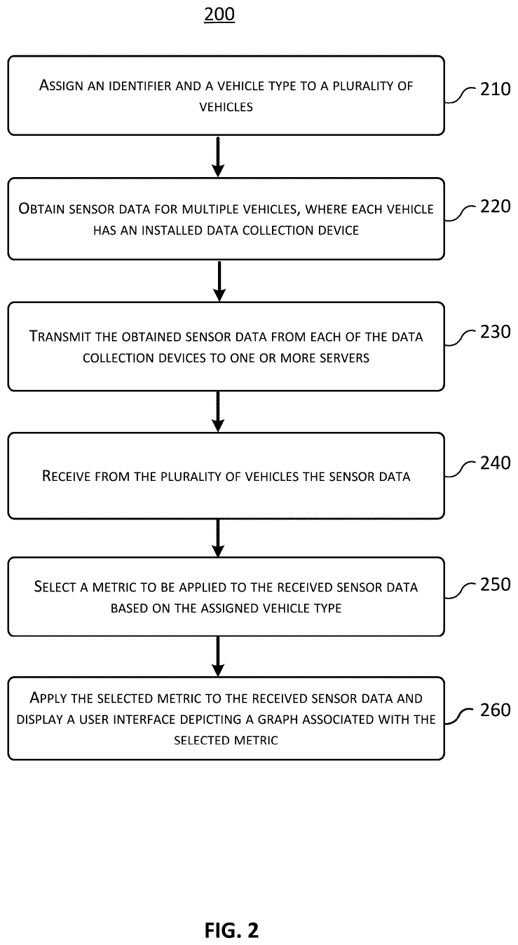

FIG. 2 is a flow chart illustrating an exemplary method 200 that may be performed in some embodiments. In step 210, an identifier and a vehicle type are assigned to multiple vehicles. The identifier is used by the system to associate sensor data and onboard vehicle data collected by the data collection device. For example, a company may want to evaluate a fleet of heavy equipment operating in an area to determine individual vehicle utilization. In some embodiments, each of the vehicles has installed a data collection device and one more installed sensors that are not original equipment or manufacturer installed.

In step 220, during operations of each of the vehicles, the data collection device receives sensor data from the installed sensors and receives vehicle information from the ECU, CAN Bus or other vehicle information systems. The installed sensors include hydraulic pressure sensors and/or cameras. For a respective vehicle, the installed data collection device receives the data and stores the data on the data collection device. The received data may include any one or more of the following: hydraulic pressure sensor data from installed hydraulic pressure sensors, images and/or video from installed cameras and RPM information from the vehicle information. During operations of the vehicle the data collection device records its geo-spatial location. Other data may be obtained by the data collection device, such as hourmeter, odometer and additional operational values.

In step 230, each of the data collection devices transmits the obtained sensor data to one or more other computing devices, such as a server. A data collection device may be configured to transmit the obtained sensor data and vehicle information on a periodic basis, such as every second, minute, hour, day or week. Also, the data collection device may be configured to transmit the obtained sensor data after the vehicle shuts down. For example, the data collection device, determines that the RPM of the engine has dropped to zero or that the power to the vehicle has been switched off. In response, the determining the vehicle has shut down, the data collection device may initiate transmission of the collected data. The transmitted data includes a equipment identifier.

In step 240, the other computing devices or servers received the data transmitted from the respective data collection devices. For example, a server receives data from multiple data collection devices and store the received data in one or more databases.

In step 250, the system selects a metric to be applied to the received sensor data based on the vehicle type that was assigned to a particular vehicle. For example, the server receives data from multiple data collection devices installed on different types of vehicles, such as a bulldozer, excavator, dump truck, etc. The system includes predetermined or predefined metrics or rules that are used to evaluate received data for a particular type of vehicle. For example, the system may use a specific metric for an excavator vehicle type and may use a different metric for a dump truck vehicle type.

In step 260, the system applies the selected metric to the received sensor data and vehicle information data. The system generates and displays a user interface depicting a graph associated with the selected metric.

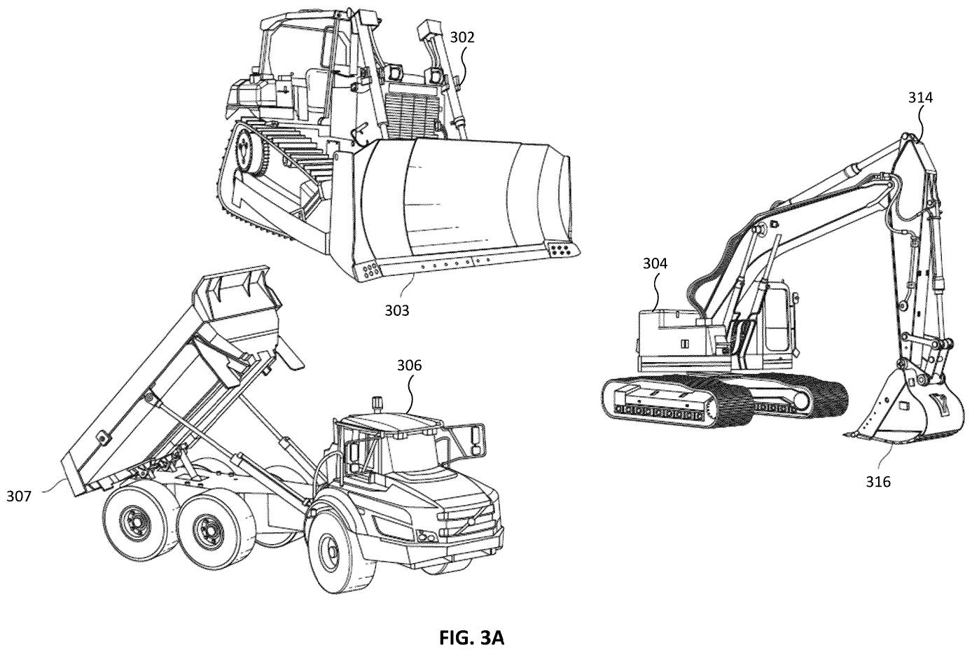

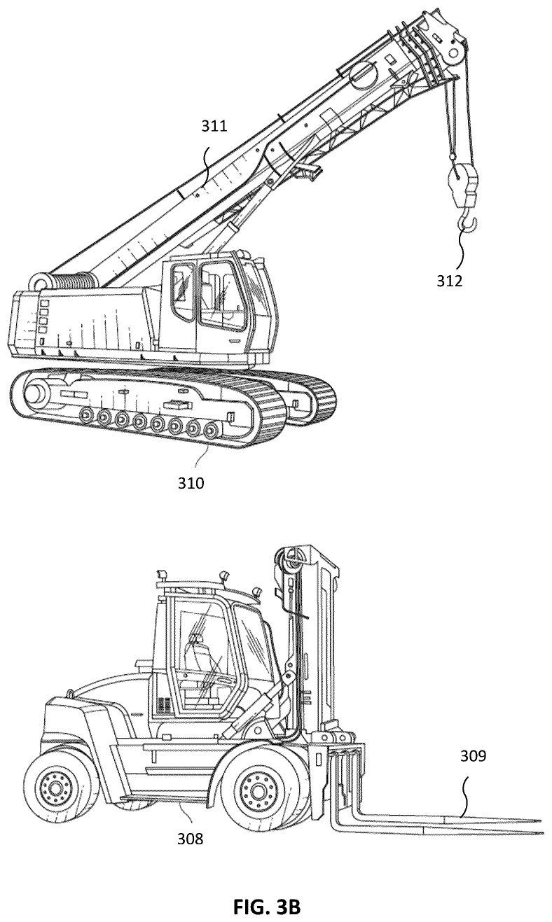

FIG. 3 is a diagram illustrating exemplary heavy equipment. While not exhaustive, examples of different heavy equipment are depicted, including a bulldozer 302, an excavator 304, a dump truck 306, a fork lift 308 and a crane 310. Each of the vehicles may have installed on the vehicle a data collection device 100.

In some embodiments, the vehicles have one or more pressure sensors installed on the vehicles. The data collection device 100 receives and stores hydraulic pressure values from the one or more pressure sensors.

In some embodiments, the vehicles have one or more load sensors installed on the vehicles to measure a load placed on a vehicle or a part or component of a vehicle. The data collection device 100 receives and stores load information values from the one or more pressure sensors.

In some embodiments, the vehicles have one or more contact sensors installed on the vehicles to measure a position of a part or component of a vehicle. The data collection device 100 receives and stores contact information values from the one or more contact sensors.

In some embodiments, the vehicles have one or more cameras installed on the vehicles to obtain video imagery of a part or component of a vehicle. The data collection device 100 receives and stores video images from the one or more cameras.

In some embodiments, the vehicles have a combination of the following sensors installed on the vehicles: one or more pressure sensors, one or more load sensors, one or more contact sensors, and one or more additional sensors.

Referring to FIG. 3A, bulldozer 302 has been assigned a equipment identifier of BD1, excavator 304 has been assigned a equipment identifier of EC1, and the dump truck 306 has been assigned a equipment identifier of DT1.

In some embodiments, the data collection device 100 installed on the bulldozer 302 is configured to read and record hydraulic pressure values of hydraulic lines that actuate or control the operation of the blade 303.

In some embodiments, the data collection device 100 installed on the dump truck 306 is configured to read and record hydraulic pressure values of hydraulic lines that actual or control the operation of the dump box 307. In some embodiments, the dump truck 306 may have an installed load sensor and the data collection device 100 may record that a load has been placed into the dump box 307. In some embodiments, the load sensor provides a weight of the load which may be received and recorded by the data collection device 100. In some embodiments, the dump truck 306 may have installed a contact sensor and the data collection device 100. The data collection 102 device receives information about the contact opening and closing when the dump box is raised or lowered.

In some embodiments, the data collection device 100 installed on the excavator 304 is configured to read and record hydraulic pressure values, via installed pressure sensors, of hydraulic lines that actuate the excavator's boom 314. In some embodiments, the data collection device 100 installed on the excavator 304 may be configured to read and record hydraulic pressure values, via installed pressure sensors, of hydraulic lines that actuate the excavator's bucket 316. In some embodiments, the data collection device 100 installed on the excavator 304 may be configured to receive video images or image frames from one or more cameras positioned to view the operation of the excavator's bucket 316.

In some embodiments, the data collection device 100 installed on the forklift 308 is configured to read and record hydraulic pressure values, via installed pressure sensors, of hydraulic lines that actuate the forks 309. In some embodiments, the data collection device 100 installed on the forklift 308 is configured to read and record load sensors installed on or about the forks 309. For example, the load sensor may monitor whether the forklift has a load (such as a pallet) being lifted by the forks 309.

The data collection device 100 installed on the crane 310 is configured to read and record hydraulic pressures values, via installed pressure sensors, of hydraulic lines that actual the movement of the crane's boom 311. Additionally, the data collection device 100 installed on the crane 310 may be configured to monitor the operation of the hoist cables. For example, a camera may be installed onto the cab, the hook or bock, or at other positions about the crane to monitor the movement of the hook or block. Additionally, the data collection device 100 installed on the crane 314 may be configured to receive video images or image frames from one or more cameras positioned to view the operation of the crane's hook or block 312.

### Computer Vision Assisted Utilization Determination

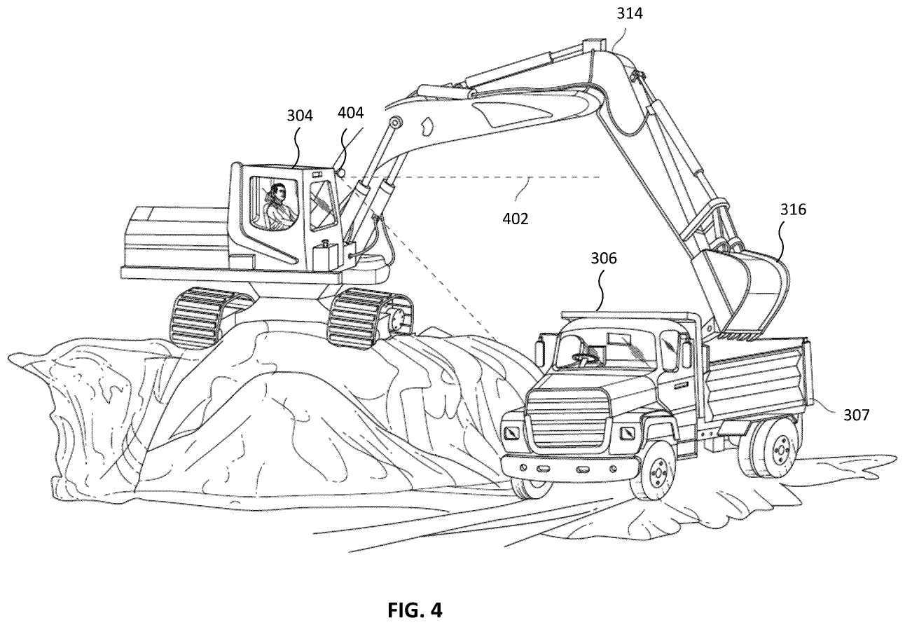

FIG. 4 is a diagram illustrating an excavator loading a dump truck. In this example, the excavator is moving dirt or Earth from a pile and loading the dirt into the dump box of the dump truck. The excavator has been assigned a equipment identifier EC1 and the dump truck has been assigned a equipment identifier DT1.

Prior to the operation of the excavator 304, an operator drives the dump truck 306 into a position for loading by the excavator. A data collection device 100 has been installed on the dump truck 306. In some embodiments, when the engine of the dump truck is started, the data collection device detects the engine has started or detects that the vehicle power has been turned on and begins monitoring the hydraulic pressure of the installed pressure sensors, begins recording sensor values, begins recording its geospatial location, and may also record RPM values of the dump truck's engine, date/time values, and receives other vehicle information. While the dump box 307 is operated, hydraulic pressure of the hydraulic lines connected to the pistons or components to operate the dump box 307 will change (such as increasing, decreasing in hydraulic pressure). For example, lowering the dump box 307 will likely cause a decrease in the hydraulic pressure, while raising the dump box 307 will likely cause an increase in the hydraulic pressure. During the period of the field operations of the dump truck 306, the data and information received by the data collection device 100 is intermittently (or continuously) received and stored on a storage device.

When the operator moves the dump truck 306 into place, the operator may or may not turn off the dump truck engine. The data collection device 100 will continue to record and receive sensor data and vehicle information while the dump truck engine is still running.

After dump truck 306 is positioned into place, the operator of the excavator may begin performing field operations to load the dump truck with material, such as dirt or Earth. A data collection device 100 has been installed on excavator 304. In some embodiments, when the engine of the excavator 304 is started, the data collection device detects the engine has started or detects that the vehicle power has been turned on and begins monitoring the hydraulic pressure of the installed pressure sensors, begins recording its geospatial location, begins recording image or video from an installed camera 404 and may also record RPM values of the excavator's engine, date/time values, and receives other vehicle information.

While excavator 304 is operated, hydraulic pressure of the hydraulic lines connected to the pistons or components to operate the excavator's boom 314 or the bucket 316 will change (such as increasing, decreasing in hydraulic pressure). For example, lowering the boom 314 or lowering the bucket box 316 will likely cause a decrease in the hydraulic pressure, while raising the boom 314 or raising the bucket 316 will likely cause an increase in the hydraulic pressure. Separate pressure sensors are installed on excavator 304 to separately obtain pressure values from the actuation of boom 314 and from the actuation of the bucket 316. During the period of the field operations of the excavator 304, the sensor data and vehicle information received by the data collection device 100 is intermittently (or continuously) received and stored on a storage device.

In some embodiments, pressure sensors are installed on the excavator, the system determines utilization when the received data indicates that the engine of the excavator is turned on (e.g., the excavator engine is running, and if any of the following activities are indicated by the received sensor data: swivel of the cabin of the excavator, boom/bucket movement, the movement of the excavator (indicated by a GPS track).

In this example, the excavator 304 may have one or more cameras installed on the excavator (such as being positioned on or about the cab of the excavator). The data collection device 100 may begin recording images or videos when the power is turned on, or when the engine of the excavator is started. The field of view of the camera 404 is positioned such that images of the bucket 316 are being recorded. The data collection device 100 may include a computer vision sub-system or processes to analyze received images and determine whether another vehicle (such as a dump truck) are within proximity of the bucket of the excavator 304. In the depicted example, the data collection device 100 would capture videos or images of the excavator 304 loading material into the dump box 307 of the dump truck 306. The data collection device determines a confidence or probability of the occurrence of the other vehicle in the image. In some embodiments, some or all of the images or video is transmitted from the data collection device 100 to the server 162. In some embodiments, the data collection device 100 transmits the indication or probability of the occurrence to the server with a date/time stamp of the indication or probability of the occurrence. In some embodiments, the system determines a number of cycles and the average fill rate and uses the bucket's measurement to calculate an amount of volume of the load moved.

### Computer Vision Assisted Cycle Time Determination

In another example, the system may use computer vision to monitor the operations of a crane 312. One or more cameras may be installed on the crane, such as on the cab of the crane or on the hook or block of the crane. The cameras obtain images or video of the operations or movement of the block or hook 312.

The system may obtain images of the block of the crane moving from an initial position (e.g., loading area) to pick up a load, and then move the load to a second position (e.g., an unloading area) and release the load at the second position, and the return to the initial position in preparation of picking up another load. The system may evaluate the images and determine a cycle count (such as the number of loads) that the crane has moved during a given period of time. Via analysis of an image, the system may detect an object attached to the block or hook 312. The system determines, by evaluating a series of images of the operation of the crane block, a cycle count of how many loads were actually transported by the crane for a time period.

Moreover, the system determines a hooking time of the crane by evaluating a series of images for a period of time. The images would indicate whether a load is or not attached to the block or hook 312. The system determines an amount of time that the images depict a load being attached to the block or hook 312. The system determines an amount of time that the images depict that no load is attached to the block or hook 312. The system determines a utilization of the crane indicating that the crane engine is running or operating and a percentage of the time when the crane has a load and a percentage of time when the crane does not have a load attached to the block or hook 312. The system generates a user interface and depict a graph displaying the utilization of the crane. The system generates a user interface depicting the determined cycle count for the period of time.

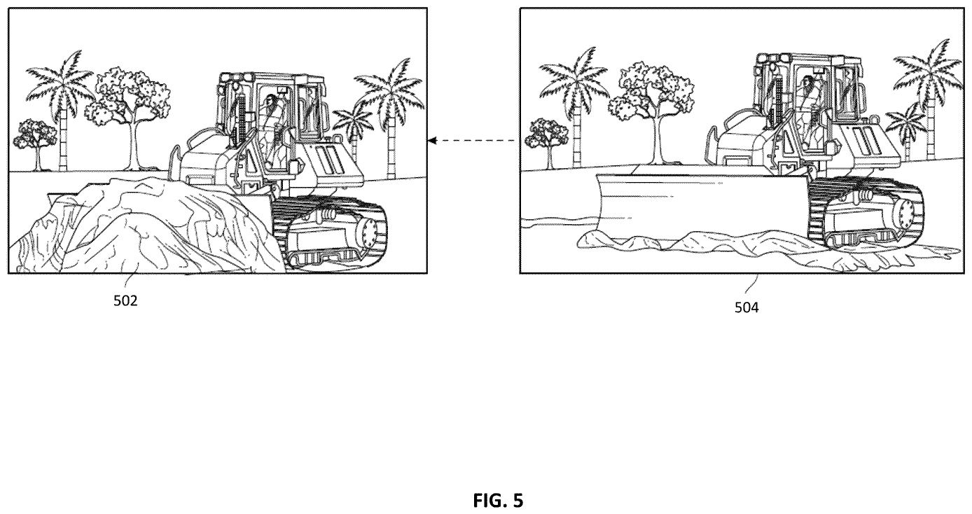

FIG. 5 is a diagram illustrating exemplary bulldozer performing field operations. In the right frame 502 the bulldozer 302 is using its blade 303 to scrape the ground and move dirt along a path 504. The operator of the bulldozer 302 moves the dirt into a pile as shown in the right frame 506. In this example, bulldozer 302 has been previously assigned a equipment identifier of BD1. Hydraulic pressure sensors were installed to measure the hydraulic pressure of hydraulic lines used to actuate the bulldozer's blade 303. During the performance of the field operations, the bulldozer 302 may sit stationary with the engine on (e.g. idling) while the bulldozer 302 is not moving. In other situations, during the performance of the field operations, the bulldozer 302 moves across the field to and from locations while operating or maneuvering the blade 303, or the blade 303 is stationary. In other situations, the bulldozer sits stationary with the engine on, but operating or maneuvering the blade 303.

A data collection device 100 has been installed on the bulldozer 302. In some embodiments, when the engine of the bulldozer is started, the data collection device detects the engine has started or detects that the vehicle power has been turned on and begins monitoring the hydraulic pressure of the installed pressure sensors, begins recording its geospatial location, and may also record RPM values of the bulldozer's engine, date/time values, and receives other vehicle information. While the blade 304 is operated, hydraulic pressure of the hydraulic lines connected to the pistons or components to operate the blade 304 will change (such as increasing, decreasing in hydraulic pressure). For example, lowering the blade 304 will likely cause a decrease in the hydraulic pressure, while raising or adjusting an angle of the blade 304 will likely cause an increase in the hydraulic pressure. During the period of the field operations of the bulldozer 302, the sensor data and the vehicle information received by the data collection device 100 is intermittently (or continuously) received and stored on a storage device. The system determines periods of non-movement of the bulldozer 302 as indicated by the multiple location coordinates of the bulldozer at the same geospatial location over a period of time (such as multiple seconds and/or multiple minutes).

In some embodiments, the data collection device 100 determines that the bulldozer 304 has stopped field operations. For example, the data collection device determines that the vehicle has stopped field operations when the engine speed has dropped to zero RPM and/or that the vehicle power has been switched off. In some embodiments, the data collection device 100 can monitor a voltage value of power being supplied from the bulldozer's battery.

In some embodiments, the data collection device 100, in response to determining that the bulldozer had stopped filed operations, will then transmit the collected sensor data and vehicle information to one or more servers 160.

FIG. 6 is a diagram illustrating an exemplary user interface 600. The system generates user interface 600 which lists one or more pieces of equipment. The user interface 600 depicts utilization and productivity graphs for respective pieces of equipment over a time period (such a number of days, weeks, months, etc.). In this example, a time period (such as a date range of 3 days) was selected by a user. In response to the selected time period, the system displays graphs showing utilization and productivity of the respective pieces of equipment for the selected time period. In this example, 3 days of graphs for the vehicles are displayed.

The user interface 600 may display an image 610 of a respective piece of equipment and may display the equipment identifier 602 (e.g., the equipment identifier BL7). Portions of the generated graphs depict a portion where the vehicle is utilized 606, and not utilized 608 during the indicated time period. The user interface 600 may display a productivity category and an amount (such as for the forklift FL12 a value of loads carried of 219 cycles; for the backhoe loader, a hydraulics activated type of 33 hours 47 minutes; for the diesel tanker, a distance traveled time of 761 km).

Also, for each of the displayed pieces of equipment, the user interface 600 displays a total utilization value in an amount of hours. Also, an amount of idling time is displayed in an amount of hours. The graphs depicted to the right of each piece of equipment depicts a comparison of the number of hours of utilization as compared to the number of hours of idling time (i.e., non-utilization) for a particular day of operations.

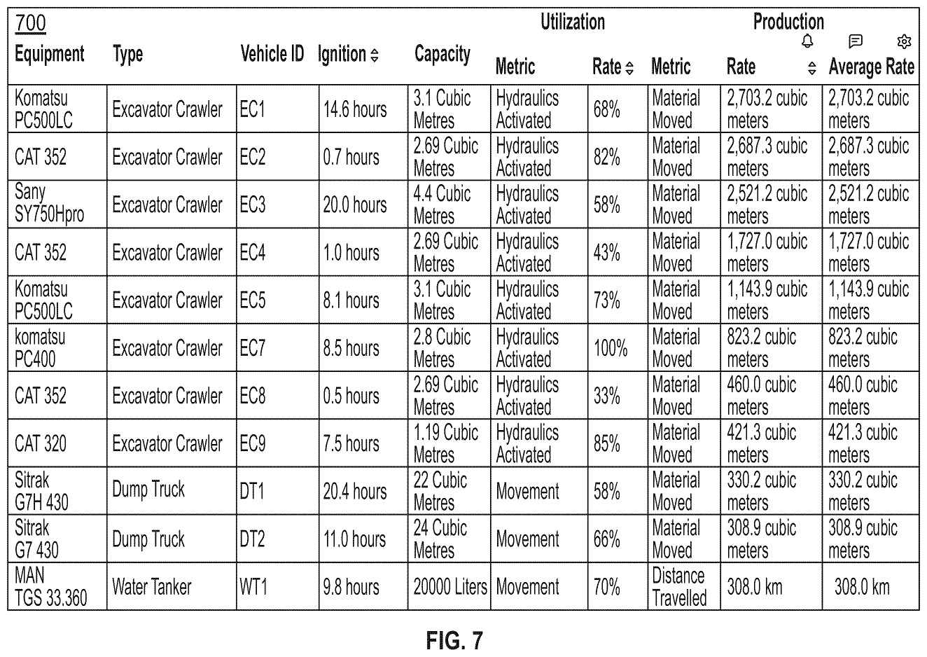

FIG. 7 is a diagram illustrating an exemplary user interface 700. The system generates user interface 700 which lists one or more vehicles with assigned information about the operation of the vehicle and the utilization of the respective vehicles. In some embodiments, each row of the user interfaces list a vehicle equipment vendor and model (such as Komatsu PC500LC), the assigned type of the vehicle (such as Excavator Crawler), the equipment identifier (such as EC1), the ignition time of the vehicle (such as the total time or hours that the vehicle engine has been operating), the load capacity of the vehicle (such as the bucket capacity of the excavator, 3.1 cubic meters), the utilization metric applied to determine the utilization of the vehicle (such as hydraulics activated), and the utilization rate (such as 68%), the productivity metric applied to determine the productivity of the vehicle (such as material moved), a rate of the productivity (e.g., a volume value such as cubic meters for material moved, or a distance value such as kilometers for distance travelled), and an average rate of productivity of the vehicle.

In some embodiments, the utilization rate is calculated by the system applying a metric for the particular vehicle type as applied to a total number of hours of ignition time (for a given time period, such as all time, a number of months, a number of weeks, a number of days, or a number of hours). In some embodiments, ignition time is determined based on the engine operation time where the engine of a vehicle has an RPM value greater than zero. In this example, the metric of Hydraulics Activated is used to determine the utilization rate of the vehicle. The Hydraulics Activated metric uses a predefined rule or algorithm to determine the hydraulics activation of the vehicle.

For example, the predefined rule or algorithm for the Hydraulics Activated metric may evaluate the received hydraulic pressure sensor values for the vehicle and determine that when the hydraulic pressure values are within a predetermined range, such as a range greater than 5 psi, the system determines that the vehicle is being utilized. In the example, either hydraulic activation of the bucket or the boom of the excavator crawler would indicate utilization. The total time of the utilization (e.g., where the hydraulic pressures are within the predetermined range), then may be calculated. The total time of the utilization may be divided by the total time of the engine ignition to determine a utilization rate.

In some embodiments, the Hydraulics Activated metric may also include an evaluation of whether the bucket of the excavator was in proximity to another vehicle (such as a dump truck). The indication of a probability or occurrence that the bucket was close to or above the dump box of a dump truck would indicate that the excavator was likely being utilized.

While the exemplary user interface depicts utilization for two excavator crawler vehicles, other vehicles and their respective metric type may be listed. For example, a dump truck may be set up for evaluation in the system. A utilization metric that may be applied to a dump truck vehicle type is movement. In this example, the system would evaluate the GPS coordinate locations of the dump truck and determine whether the dump truck is moving or not while the engine of the dump truck is running. For example, the system determines periods of non-movement of the dump truck 306 as indicated by multiple location coordinates of the dump truck 306 at the same geospatial location over a period of time (such as multiple seconds and/or multiple minutes). Movement of the dump truck may be indicated by a track or path of location coordinates of the dump truck at different locations. The system determines utilization where the dump truck is moving and the engine is running. The system determines non-utilization where the dump truck is not moving the engine is running.

In another example, a bulldozer may be set up for evaluation in the system. A utilization metric that may be applied to a bulldozer vehicle type is blade activated. In this example, the system would evaluate the received pressure sensor values related to the operation of the blade of the bulldozer. The system determines, at least in part, utilization of the bulldozer, when the blade is indicated activated based on an evaluation of the received hydraulic pressure while the engine of the bulldozer is running. The system determines non-utilization where the bulldozer blade is not being repositioned and the bulldozer is not moving (according to its recorded location coordinates, and where the engine is running.)

### Cycle Count Determination

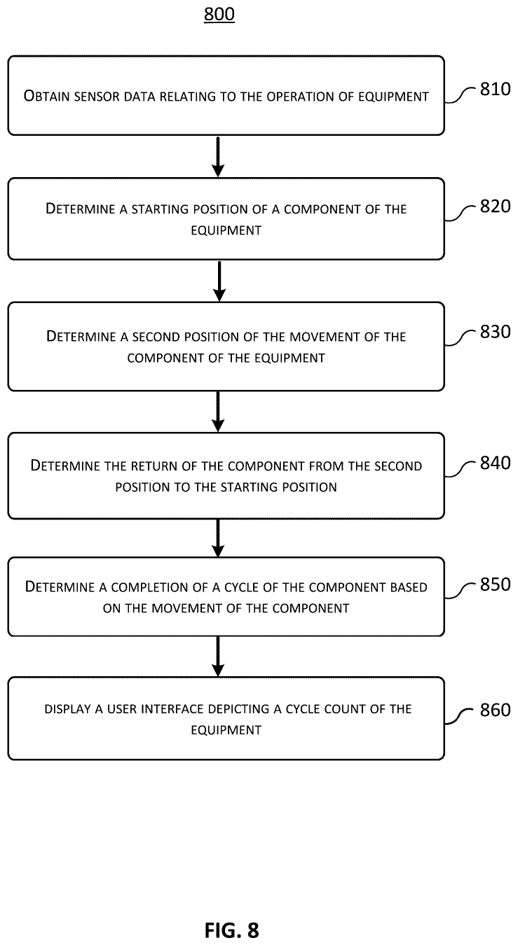

FIG. 8 is a flow chart illustrating an exemplary method 800 that may be performed in some embodiments. In some embodiments, the method performed by the system determines a number of cycles or repetitive operations performed by equipment or a vehicle.

In step 810, the system obtains sensor data relating to the operation of a vehicle or equipment.

In step 820, the system determines a starting point of a component of the equipment.

In step 830, the system determines a second position of the movement of the equipment.

In step 840, the system determines the return of the component from the second position to the starting position.

In step 850, the system determines a completion of a cycle of the component based on the movement from the starting position to the second position and back to the starting position.

In step 860, the system generates a user interface depicting the determined cycle count of the vehicle or equipment. The cycle count is used as a factor or value in determining the utilization of the equipment or vehicle.

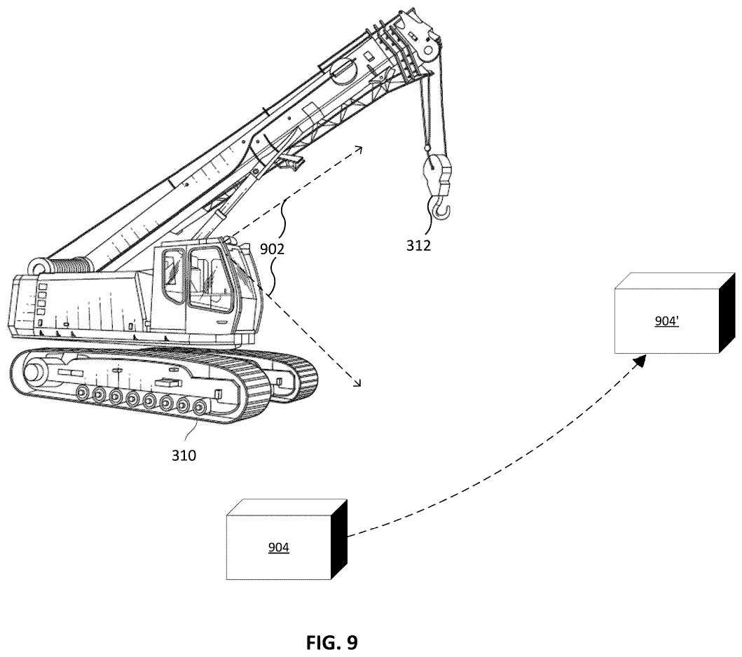

FIG. 9 is a diagram illustrating a vehicle performing repetitive operations. In this example, a crane 310 is performing operations to move loads from a loading area to an unloading area. The figure illustrates an installed camera with a field of view 902 recording images and/or video of the operations of the block or hook 312. In some embodiments, the camera is installed on the hook or block. A data collection device 100 receives and records operational information that the crane engine is running and receives and records the images and/or video. An example load 904 is shown at an initial loading area. The hook 312 is attached to the load 904 and moved by the crane 310 to an unloading area. The example load is shown at the unloading area as 904′. The crane performs multiple loading and unloading operations. The system determines cycle counts of the crane indicating a utilization of the crane during the running of the crane engine.

### Non-Vehicle Equipment Utilization Determination Examples

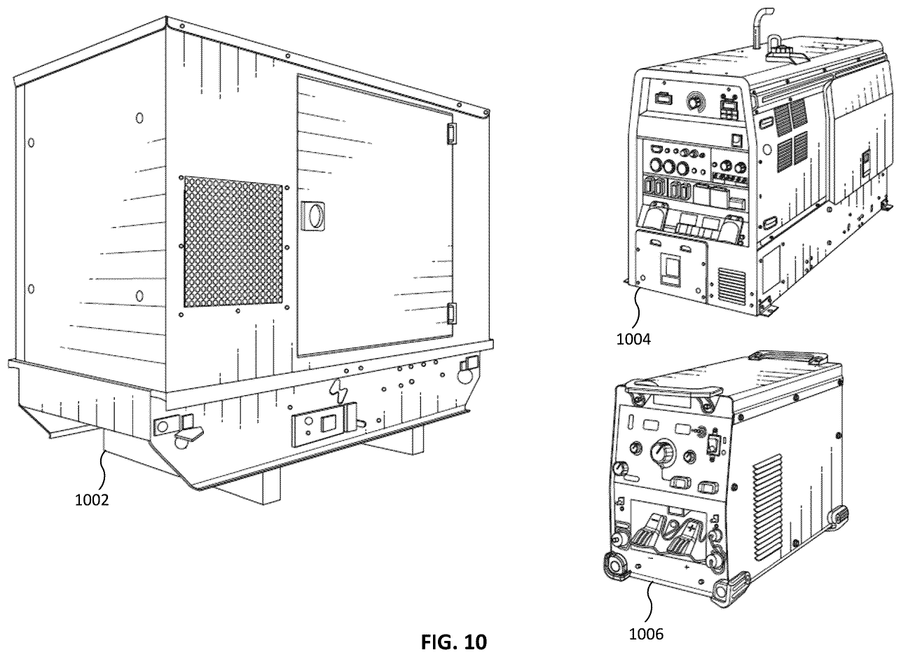

FIG. 10 is a diagram illustrating generators and welding machines. In some embodiments, the system determines the utilization of non-vehicle equipment, such as generators, air compressors, welding machines or other equipment. For example, the system determines utilization of a generator 1002, a welding machine with a generator 1004 or a welding machine 1006. Moreover, the system determines an estimated emissions output for the generator 1002 and the welding machine with the generator 1004 (see emissions estimation discussion below).

In some embodiments, a data collection device 100 may monitor when a welding machine is switched on and when a welding operations are being performed. The system determines a utilization for a time period when the welding machine was switched on and an amount of time when the welding machine was actually being used. For example, a sensor may be installed on the welding machine, such as a reed switch. The data collection device 100 receives sensor data that the welding machine has been switched on and received sensor data about welding machine performing operations, such as generating an arc. The system generates a graph or information depicting a utilization, such as a percentage of time when the welding machine is running and that the welding machine is generating an arc, and a percentage of time when the welding machine is running and that an arc is not being generated. The system generates a user interface depicting the utilization of the welding machine. One or more welding machines may be monitored by the system. Each of the welding machines may be assigned a unique identifier to the welding machine for display via the user interface.

In some embodiments, a data collection device 100 may monitor when a generator engine is running and when power from the generator is being drawn. The system determines utilization of a time period when the generator is running and an amount of time when power is being drawn from the generator. Sensors may be attached to the generator to observe amperage being drawn from the generator. The data collection device 100 receives sensor data that the generator engine is switched on or running and receives sensor data about amperage being drawn or an electrical load being placed on the generator. The system generates a graph or information depicting utilization of the generator, such as a percentage of time when the generator is running and that that a load or amperage is being drawn from the generator. The system generates a user interface depicting the utilization of the generator. One or more generators may be monitored by the system. Each of the generators may be assigned a unique identifier to the generator for display via the user interface.

In some embodiments, a data collection device 100 may monitor when an air compressor engine is running and when the air compressor is being used to supply compressed air. The system determines a utilization for a time period when the air compressor is running an when air and compressed air is being provided by the air compressor. For example, an air pressure sensor may be attached line to the hose or compressed air chamber. The data collection device 100 receives air pressure readings from a pneumatic pressure sensor while the air compressor is turned on. The system determines that when the air pressure is a static or within a predetermined air pressure range, that the air compressor is not being used. The system determines that when the air pressure drops or within another predetermined air pressure range that the air compressor is being used. The system generates a graph or information depicting a utilization, such as a percentage of time when the air compressor is running and that air is being dispensed, and a percentage of time when the air compressor is running and that air is not being dispensed. The system generates a user interface depicting the utilization of the air compressor. One or more air compressors may be monitored by the system. Each of the air compressors may be assigned a unique identifier to the air compressor for display via the user interface.

### Emissions Estimation Based on Prior Obtained Emissions Fingerprint

In some embodiments, the system determines an estimated amount of emissions output for equipment that has an engine which produces gas emissions. Equipment includes any equipment, vehicles or other devices the use a gas or diesel engine. An initial emissions fingerprint for each equipment is obtained and stored on a storage device accessible by a server.

In some embodiments, the initial emissions fingerprint may be determined for each piece of equipment. The fingerprint comprises values for gas emission produced at multiple different RPM levels of an engine of the equipment. Over the course of operating the equipment, emissions data may be collected by the system. Based on the emissions fingerprint, the system determines an emissions output for each piece of equipment.

In some embodiments, the system determines the emissions output for a respective piece of equipment based on the duration of the operation of a particular equipment at the multiple different RPM values. The system uses the obtained equipment operational data along with the first emissions fingerprint to a graph and emissions output values of emissions produced by the equipment.

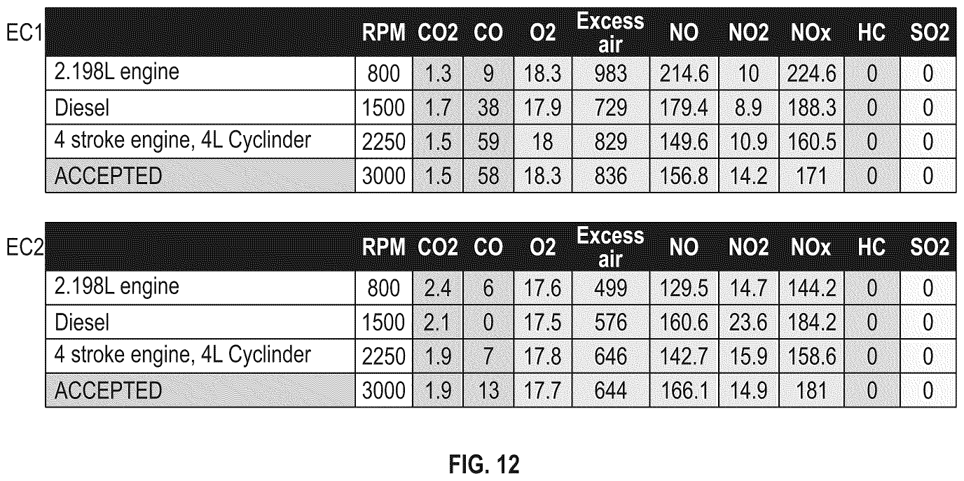

In some embodiments, the system interpolates between RPM values of the received equipment data, to determine emission output values between RPM values of the emissions fingerprint. In the example emissions fingerprint depicted in FIG. 12, the system may interpolate and determine emissions values below 800 RPM, between 800 and 1500 RPM, 1500 and 2250 RPM, and between 2250 and 3000 RPM, above 3000 RPM. For example, an interpolated CO2 value between 800 and 1500 RPM for a received RPM value of 900 for vehicle EC1 may be 1.4.

Later after the equipment has been operated for a period of time (such as many weeks or months), a second or new emissions fingerprint for each of the equipment is obtained. Over the course of operating respective equipment, emissions data may be collected by the system, and the system determines an emissions output for each of the multiple vehicles using their new emissions fingerprint. In some embodiments, the emissions output is calculated based on the duration of the operation of a particular equipment at multiple different RPM values in reference to the first emissions fingerprint. In some embodiments, the system generates a graph and emissions output values of emissions produced by the equipment based on the second or new emissions fingerprint. In other embodiments, the system uses the newly obtained emissions fingerprint to calibrate the initial emissions fingerprint, thereby creating a calibrated emissions fingerprint. The calibrated fingerprint is then used by the system to determine the emissions output for a particular piece of equipment.

In some embodiments the machine learning model includes other supervised learning methods like support vector machines and neural networks. Machine learning systems included classification and regression trees, decision trees, and a gradient boosting model. The machine learning network may be of various network types (e.g., convolutional neural network, an artificial recurrent neural network (RNN), a feedforward neural network (FNN), or other neural network types). In an RNN, connections between nodes of the network form a directed graph along a temporal sequence. In an FNN, when training the network information only moves forward in one direction from input nodes through any hidden nodes to output nodes. In the FNN, there are no cycles or loops in the machine learning network.

In some embodiments, the machine learning model may be trained using multiple emission fingerprints for different vehicles. In addition to RPM values, an input of a equipment identifier may be utilized with the trained machine learning model. The trained machine learning model may then determine emission values specifically for a specific vehicle. Additionally, the trained machine learning model receives a type, category, make and/or model of vehicle or an engine of a vehicle along with RPM values.

The system applies a different model depending on whether the fuel value information is received by the server from the data collection device. The system selects from three different machine learning models, with the first model providing the most accurate estimation of emissions.

The described methodologies herein enables comprehensive analysis of work patterns through the integration of multiple data streams, including but not limited to hydraulic pressure readings, engine telemetry, geospatial positioning data, and visual information captured through mounted cameras. The objective is to determine equipment utilization patterns through different subsets of such multi-modalities augmenting the base readings, where the ML models which are at the core of this system leverage this modality augmentation to enhance their pattern recognition capabilities and robustness in utilization prediction.

### The Fundamental Problem: Why Machine Learning Over Rule-Based Systems

Traditional rule-based approaches to utilization determination fail because operational patterns are highly variable and context-dependent. A simple threshold approach cannot distinguish between productive work, non-productive activity, or anomalous conditions due to this complex nature of operations. The relationship between sensor values and actual utilization states is nonlinear, time-dependent, and varies across equipment types, environmental conditions, and operational contexts.

The ML objective in the system is to learn complex, multivariate mappings from multimodal observations to utilization states that generalize across operational variability without manual threshold/condition tuning for each deployment. The model infers latent work patterns from observable signals, handling noise, missing data, and evolving operational procedures.

### Processing Multiple Sensor Modalities

The system processes concurrent data streams from heterogeneous sensors, each providing complementary information about operational state: (i) scalar sensors including but not limited to hydraulic pressure, engine RPM, temperature, accelerometer readings that capture internal states of the machine but without operational context, (ii) geospatial sensors including but not limited to GPS, IMU that capture movement, positioning characteristics, and coordination patterns between units, (iii) vision sensors, i.e. cameras mounted on or in the equipment, that capture operational context about what objects are present, what their spatial relationships are, their motion patterns.

Learning objective for individual modalities is to extract relevant features that correlate with operational states. For scalars: extracting temporal patterns; for geospatial: extracting trajectories and positioning features; for vision: identifying objects, tracking motion, extracting spatial relationships. The system processes these inputs simultaneously through specialized computational pathways designed for different data types.

In various embodiments, the system employs modality-specific ensembles of neural network architectures depending on the sensor availability:

For temporal scalar sensor processing, the ML objective is learning which temporal patterns in sensor readings (extracted features) correspond to which operational states.

Architectures include but are not limited to: Recurrent neural networks (LSTM, GRU) that maintain internal memory states, enabling context-dependent interpretation where a shift in sensor readings can be interpreted differently depending on context; Transformer architectures with multi-head self-attention that process entire time windows simultaneously, learning which past moments are relevant to current state without sequential processing; and/or Temporal Convolutional Networks (TCN) with dilated convolutions detecting patterns at multiple time scales.

For vision sensor processing, multiple learning objectives operate in ensemble:
Object detection objective: identifying (class label) and localizing (bounding boxes) entities (equipment, equipment parts, people, payloads, environmental objects). Architectures include but are not limited to: Single-stage detectors (YOLO, SSD families) that process full images through convolutions yielding class probabilities and bounding boxes in one forward pass; Two-stage detectors (RCNN, Fast-RCNN, Faster-RCNN families) that utilize region proposal networks identifying candidate regions and refinement networks adjusting bounding boxes and classifying contents with higher accuracy; and/or Transformer-based detectors (DETR family; CNN+Encoder+Decoder+FFN, ViT) applying attention mechanisms to image features to learn object locations without predefined boxes all at once.
Temporal tracking objective: maintaining consistent object identities across frames and enabling trajectory analysis. Architectures include but are not limited to: Kalman filter-based approaches (SORT, IoU Tracker) using motion prediction models; Deep learning trackers (DeepSORT, ByteTrack, StrongSORT) using appearance embeddings and motion patterns; and/or Transformer-based trackers (TransTrack, MOTR) that jointly detect and track with attention.
Motion analysis/classification objective: extracting dynamics indicating operational activity. Architectures include but are not limited to: Optical flow computation (Farneback, FlowNet, RAFT) generating motion fields; 2D CNN and its variants (LRCN, Fusion) processing image tensors for classification of sequences (action, state, relationship); Action recognition networks (TSN, I3D, TimeSformer, SlowFast) processing video streams as tensors; and/or Vision backbones in all above architectures supporting these objectives include but are not limited to ResNet, EfficientNet, MobileNet families (convolutional), Vision Transformers (ViT, Swin, DINO), or hybrid architectures combining convolutions with attention mechanisms.

For geospatial sensor processing, multiple learning objectives extract operational insights from positioning and motion data: Trajectory analysis objective, Multi-unit spatial coordination objective, and Motion dynamics objective as described below:

Trajectory analysis objective: learning movement patterns to distinguish productive work from non-productive repositioning. Architectures include but are not limited to: RNNs (LSTM, GRU) processing sequences and maintaining trajectory memory to interpret current movement based on path history; Transformer architectures with spatial-temporal attention processing trajectory windows, learning which past positions inform current movement intent; and/or TCNN detecting movement signatures such as circular patterns, back-and-forth motions, sustained directional movement.

Multi-unit spatial coordination objective: identifying spatial relationships and coordination patterns between multiple tracked equipment units. Architectures include but are not limited to: Graph Neural Networks (GNN) where units are nodes with learned spatial/temporal edges, message passing identifying collaboration patterns; and/or Spatial-temporal transformers processing trajectories to identify coordination events and to compute position relevance across units.

Operational zone discovery objective: learning site-specific operational boundaries such as loading bays, dump zones, travel corridors from spatial distributions. Architectures include but are not limited to: Clustering algorithms (DBSCAN, hierarchical clustering, GMM) discovering clusters without predefined zones; and Temporal state models learning relation between zone transitions and operational state changes.

Motion dynamics objective: extracting nuanced characteristics such as vibration patterns, orientation changes, acceleration events. Architectures include but are not limited to: RNNs for temporal smoothing and state inference; 1D-CNNs for processing time-series and detecting motion signatures; Frequency-domain feature extraction (FFT) feeding classifiers to distinguish idle vs active observations; and/or Hybrid architectures combining CNN feature extraction with RNN temporal modeling.

The system learns a mix of aforementioned contextual patterns to understand operational states. Fixed heuristics or rulesets cannot capture such complex patterns. No single modality fully determines utilization. For example, high pressure without visual payload confirmation could indicate malfunction; hook near object without pressure increase might be coincidental proximity. The system is configured to reason across modalities.

### Cross-Modal Fusion for Utilization Inference

In some embodiments, the system integrates features extracted from all available modalities into unified utilization predictions. The challenge is that modalities have different structures (1D sensor sequences, 4D video, 3D trajectories), sampling rates, and information content. Simply concatenating raw inputs fails, so the model has to learn semantic correspondences. However, not all sites or deployments have complete sensor suites. The architecture to that end functions with available modalities: full multimodal fusion when all sensors present, graceful degradation to single-modality inference when others unavailable.

Fusion architectures include but are not limited to: (i) hierarchical fusion where modality-specific encoders transform raw inputs into common-dimensionality feature representations, followed by integration layers, concatenation-based fusion processing stacked features through fully connected networks, attention-based fusion (cross-modal attention, self-attention, multi-head attention, transformer architectures) learning which features and modalities are relevant, graph-based fusion representing modalities as nodes with learned edge weights; (ii) gating mechanisms and domain-knowledge for dynamically weighting modality contributions based on availability, reliability estimates, and operational context; (iii) early/late/mid-level fusion combining at raw feature, prediction, or intermediate representation levels with learned selection of optimal fusion depth per task. Models trained with random modality dropout (masking sensors during training) learn to function with any input subset, while attention mechanisms naturally down-weight absent modalities. Fusion outputs include but are not limited to utilization state classifications (idle, active, maintenance), continuous metrics (load percentage, productivity scores), and confidence estimates reflecting multimodal agreement.

Training with Realistic and Flexible Supervision

In some embodiments, Model weights, the learned parameters determining network transformations, are optimized through ensemble training strategies adapted to available supervision. The critical challenge is that dense annotation is impractical for industrial deployments. Models initialize whenever feasible from weights pre-trained on large-scale datasets to provide general feature representations via transfer learning that reduce data requirements. Training leverages multiple supervision sources including but not limited to: (i) weak supervision from coarse labels (e.g. operator reports, logs, equipment hour meters), (ii) self-supervised learning exploiting data structure through temporal consistency, cluster-based pseudo-labeling, cross-modal correlation, or masked reconstruction, (iii) semi-supervised learning with iterative pseudo-labeling, self-training with progressive confidence-based selection (iv) active learning by identifying high-value samples through uncertainty sampling, diversity-based sampling, query-by-committee, or expected model change metrics. Ensemble training employs multiple models with different architectures, supervision strategies, and initializations with learned ensemble weights optimizing combination. Training, when applicable, employs gradient-based optimization against available supervision with proper regularization and hyperparameter tuning.

### Generalization and Adaptation Across Deployments

In some embodiments, operational patterns vary across sites, equipment configurations, and conditions, making site-specific model training for every deployment impractical. The system to adapt to that reality employs: (i) transfer learning where models trained on source domains adapt to target domains through fine-tuning, with pre-trained weights encoding general patterns, (ii) domain adaptation techniques when target data is scarce including adversarial training for domain-invariant representations, distribution matching and alignment, and multi-task learning where shared representations serve related tasks, (iii) zero-shot deployment where pre-trained models provide immediate predictions on new sites without site-specific training, with initial reduced-confidence predictions enabling baseline functionality during operational data collection; (iv) continual learning adapting to evolving patterns through online learning (incremental weight updates), active learning (flagging uncertain predictions for feedback), periodic retraining triggered by drift detection (monitoring performance degradation), and incremental updates preserving previous knowledge while incorporating new patterns.

### Edge Deployment Optimization

In some embodiments, equipment-mounted devices have limited compute, memory, power, and bandwidth; standard server-side models might prove to be impractical for real-time edge inference out-of-the-box. In various embodiments, optimization approaches include but are not limited to: (i) model compression via quantization (reducing precision FP32→FP16/INT8 through post-training calibration, quantization-aware training, mixed-precision strategies, dynamic bit-width selection), network pruning (magnitude-based, structured, unstructured, iterative with fine-tuning), knowledge distillation (compact models mimicking larger models through response-based, feature-based, relation-based, self-distillation, cross-modal distillation), and efficient architecture design (neural architecture search, prioritizing efficient architectures with comparable performance); (ii) bandwidth optimization via edge inference (full model inference on equipment processors transmitting only predictions/events), edge-cloud hybrid (edge preprocessing with cloud refinement), adaptive streaming (dynamic frame rate, resolution, compression quality adjustment), region-of-interest encoding, and feature compression (transmitting learned representations versus raw data); (iii) power optimization via dynamic model selection (model zoo of varying complexity with activity-based or uncertainty-based selection), duty cycling (sleep mode during idle periods with motion sensor wake triggers), adaptive sampling (variable sensor rates, frame skipping), and hardware acceleration (leveraging edge AI processors with hardware-specific optimizations and accelerated model compilation).

Modular architecture supports integration of additional sensor modalities (including but not limited to thermal, sonar, LIDAR and their respective temporal state changes) through new branches connecting to existing fusion infrastructure, enabling capability expansion without core redesign. The architecture predicts utilization patterns and potential inefficiencies in extremely convoluted and complex operational settings. Through continuous learning from multimodal data streams, the system refines its predictive capabilities to identify utilization patterns, detect operational inefficiencies, and support proactive planning based on historical and real-time operational data.

In addition to the utilization and operational state prediction methodology discussed in detail above, in various operational contexts where equipment performs repeated task cycles, including but not limited to loading/unloading, moving/stopping, engaging with an entity, or any type of transition between operational states over a predefined time window, the system leverages the predicted states, utilization levels, and multimodal features to provide further insights on such task cycles, describing the nature of workload in greater detail. Building on the state predictions and multimodal processing, the system identifies including but not limited to cases when equipment transitions from idle to active operation, completes discrete tasks over a certain time, moves with or without performing actual work, and returns to original position/state or starts a new cycle. These sequences of operational events constitute cycles that characterize actual work patterns.

The added complexity of identifying such cycles which require integrating multiple streams of factual and predicted datapoints calls for not a single ML model but a highly advanced ML-driven system fusing these raw, processed, and predicted inputs from multiple streams. These inputs are represented as time-series and state-based data in complex tensors with high dimensionality, processed through hierarchical fusion architectures.

Cycle boundary detection employs temporal models that segment continuous operations into discrete cycles by identifying state transition patterns. In various embodiments: (i) supervised approaches where models (recurrent networks, transformers) trained on labeled cycle boundaries learn to recognize transition signatures (idle→active marking cycle start, active→idle marking cycle end), (ii) unsupervised change-point detection algorithms identifying distribution shifts in state probability sequences, (iii) probabilistic models (HMMs, CRFs) learning state transition probabilities and cycle-level structure.

Payload and object relationship analysis (applicable to equipment where engagement with objects defines cycles-cranes, forklifts, excavators, loaders) where the system uses detection and tracking outputs o compute spatial-temporal relationships between equipment components and candidate objects. Features include proximity patterns over time, motion correlation (velocity vector correlation indicating coupled vs independent motion), and temporal consistency of relationships. Ensemble classification (neural networks, attention mechanisms, recurrent models) determines which objects are engaged payloads/entities versus environmental objects. This enables cycle characterization based on payload type and engagement characteristics.

An objective of the system and methods is deriving cycle frequency and cycle characteristics within given timeframes to improve understanding of actual work by explaining its nature in greater granularity. The methodology creates a comprehensive picture of operational patterns, enabling: (i) benchmarking through statistical analysis, (ii) identifying inefficiencies by comparing cycle characteristics against learned norms, (iii) defining expected cycle characteristics for different operation types, (iv) real-time cycle detection and historical trend analysis to identify drifts from expected patterns.

The dynamic nature of the ML-based approach similarly adapts to underlying changes through continual learning: online learning with incremental updates, active learning flagging uncertain predictions for feedback, periodic retraining triggered by drift detection, and incremental techniques preserving learned patterns while incorporating new behaviors. The methodology's extensible design supports addition of new modalities and functionalities, identifying environmental changes, operator behavior patterns, multi-equipment coordination, or other operational cues, broadening analytical scope and maintaining robust decision-making across diverse equipment types and work environments.

The disclosed methodologies herein distinguishes itself by integrating multimodal sensor processing, cross-modal fusion, and cycle-level analysis into a unified system that operates reliably even when sensor availability, quality, or operational conditions vary. The novelty lies in how the system combines heterogeneous data streams, modality-specific learning pathways, fusion strategies that adapt to missing or unreliable modalities, and downstream cycle boundary detection using both predicted states and multimodal temporal features. This addresses concrete technical problems such as the insufficiency of rule-based thresholds, the nonlinear and context-dependent nature of equipment behavior, and the challenge of deriving cycle-level insights from noisy, asynchronous, or incomplete data. The system and method include structured steps of ingesting available sensor modalities, extracting learned features per modality, fusing these representations through adaptive mechanisms, generating utilization or state predictions, and using these predictions together with multimodal signals to identify cycle boundaries and characterize operational patterns. These elements collectively provide a practical and extensible technical solution for real-world equipment utilization and cycle analysis.

First Machine Learning Model—The first model uses both fuel consumption and an equipment-specific Gamma Coefficient derived from emission signature data. In some embodiments, the emission value may be determined using a fuel amount value from a particular value. The system receives, in addition to the RPM values, values of fuel used by the vehicle for the amount of time that the engine was operated. The system applies a coefficient value to values associated with the emissions fingerprint value of the vehicle. For example, a formula as follows is used to determine emissions, where emissions=fuel amount*co-efficient value*gamma. In this example, the system uses a coefficient value of 2.7 correlating diesel fuel consumption to its resultant emission. The coefficient value used for petrol (gasoline) fuel consumption is 2.3. The gamma factor is predicted from emission signature data.

Fuel value is obtained from an analog sensor and/or from the CAN of the equipment. The data collection device receives the fuel values (such as fuel remaining, the amount of fuel consumed and/or the amount of fuel) and transmits the fuel values to the server. In some embodiments, the system determines emissions as: Emission=fuel value*co-efficient value*Gamma Coefficient. The Gamma coefficient is obtained from the emissions fingerprint and some operational variables and an ML model. The fuel value represents the amount of fuel consumed by the machine (for a given time period). The number of units may be in liters, gallons, etc. The coefficient value is a value used for the particular fuel type used by the equipment. In some embodiments, the system uses a co-efficient value of 2.7 for diesel fuel type or a co-efficient value of 2.3 for a petrol/gasoline fuel type. A gamma coefficient is derived based on obtained emissions fingerprint data for a particular vehicle. The gamma coefficient accounts for the unique emission characteristics of each machine, influenced by factors such as: machine type (e.g., generator, compressor), engine life or engine condition, maintenance history, or fuel quality.

As described herein an emissions fingerprint (e.g., emissions signature data) is obtained by using emissions testing/reading equipment to collect real-time emission signatures based on RPM (revolutions per minute) readings for a specific piece of equipment. Each piece of equipment may have its own unique emissions fingerprint. Table 3 describes an example of an emissions fingerprint indicating measured gas output at different engine RPM operating levels.

TABLE 3

| RPM | CO2 | CO | NOx | SO2 |
|---|---|---|---|---|
| 600 | 1.82 | 0 | 295.5 | 0 |
| 1100 | 2.27 | 0 | 328.6 | 0 |
| 1600 | 2.48 | 19 | 317.1 | 0 |
| 2100 | 3.17 | 26 | 239.6 | 0 |

The emissions fingerprint may be based on emission data based on different equipment operating modes. For example, the system generates vehicle or equipment diagnostics from daily operation using RPM, machine load, engine temperature etc. that are compared to the vehicle's emissions fingerprint. An emissions fingerprint may also be obtained with respect to a generator with an engine.

The system determines a CO2 Emission Coefficient. For each machine, a specific coefficient is calculated to model the relationship between CO2 emissions and RPM. This can be achieved by fitting a quadratic equation to the data using the following formula: fuel=a+b*RPM+c*RPM², where: a, b, and c: Coefficients specific to the machine.

In some embodiments, for each machine, the system uses the equation derived above to create a curve representing CO2 emissions based on RPM. The system calculates the area under this curve (AUC). This value reflects the overall CO2 emissions profile of the machine. Machines are then ranked based on their AUC values, establishing a relative order of their emission intensity. Finally, the AUC values are normalized to a range between 0.75 and 1.25. This normalization step ensures the gamma factor remains within a manageable range while preserving the ranking based on emission intensity. The resulting gamma factor for each machine is then used in the main emission calculation formula, providing a more accurate assessment of individual machine emissions.

Second Machine Learning Model—In some embodiments, when the actual fuel values are not available from the equipment, via the data collection device, the system is configured to use one or more trained machine learning ML models to predict the fuel value for the equipment. The second model uses an estimated fuel value for a particular piece of equipment. An estimated fuel value from ML model using operational variables x co-efficient value*Gamma Coefficient.

One or more machine learning models may be trained on data obtained for the operation of different equipment. For example, the model may be trained on operational values, including operational time, distance covered, and type of equipment. Additionally, utilization time and idling time are optional features that can be included depending on the specific needs of the model.

In some embodiments, the system uses a Decision Tree Regressor to determine within data and automatically selects features for prediction. The system sets various parameters for the decision tree regressor:
Loss Function (Mean Squared Error): This metric guides the model during training, helping it identify the best way to split the data to minimize the prediction error (difference between predicted and actual fuel use).
Splitting Strategy (Best): This ensures the model selects the most effective split for each decision node, leading to a more accurate final prediction tree.
Maximum Depth: This parameter controls the model's complexity by limiting the number of splits it can make. This helps prevent overfitting, where the model memorizes the training data too closely and performs poorly on unseen data.

Third Machine Learning Model—The third model uses only the RPM values for a particular piece of equipment without considering actual or estimated fuel values. From RPM data from the sensor devices and from the Emissions fingerprint. In some embodiments, the system selects from different emissions models to determine an estimated emissions output for a particular piece of equipment. The emissions data values for the different measured gases are used for the emissions fingerprints. Later, RPM values of the equipment are obtained and based on the duration and RPM values the system determines an amount of particular gas emitted by the equipment.

In some embodiments, one or more machine learning models are trained to determine the emissions output values for the particular equipment. The input values may include the RPM values of the particular equipment over a period of time. The trained machine learning model determines emission values for the equipment. Moreover, the machine learning model may be trained to apply the coefficient value for the type of fuel that the equipment uses. For example, the machine learning model may multiple the determined emissions value by a coefficient value of 2.7 for diesel fuel, and another coefficient value for those equipment with regular gasoline engines.

In some situations, a piece of equipment may initially provide fuel values from an analog sensor installed on the equipment to measure fuel levels and/or fuel levels are obtained from the CAN of the equipment. The data collection device transmits the fuel values to the server. Over the course of time, either the analog sensor and/or the CAN may no longer provide the fuel levels used to estimate generated emissions for a piece of equipment. The system determines that the analog sensor based fuel values and/or the fuel values form the CAN are not being provided by the data collection device, and then may select the second and/or third model to estimated generated equipment emission.

In the case where a specific fingerprint does not exist for a specific piece of equipment, the other input values of the equipment, such as a make or model of the equipment, is used to provide a general or best estimate of the emissions output the specific equipment. For example, the model may be trained on multiple vehicles (such as an excavator) with each vehicle have an emissions output measured. If the emission of another similar excavator has not yet been measured (i.e., no emission fingerprint exists), the system may be determined probable emission values for this vehicle based on the aggregate or average emission fingerprints of the other multiple pieces of equipment.

### Determining Working and Non-Productive Emissions Output

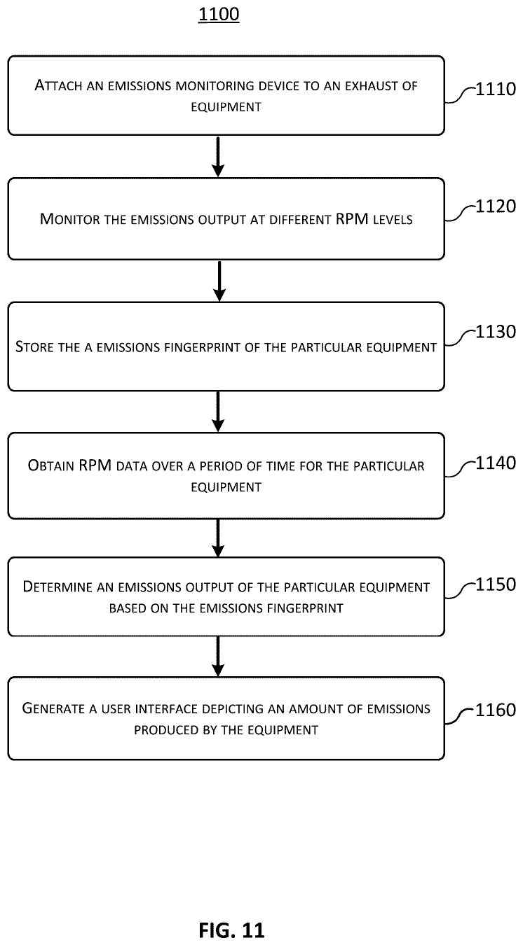

FIG. 11 is a flow chart illustrating an exemplary method 1100 that may be performed in some embodiments. The method performed by the system provides for the assessment of emissions generated by a piece of equipment (such as a vehicle, a generator or welding machine w/an engine) that produces gaseous emissions.

In step 1110, an emissions monitoring device is attached to or near the exhaust of the equipment to process exhaust gas from an engine of the piece of equipment. The emissions monitoring device may be an emissions monitoring device typically used for determining the mixture of gases output by an engine.

In step 1120, data is collected by the emission monitoring device and data regarding engine RPM values are obtained. The engine is operated at different RPM levels and emissions output data is obtained as emissions generated at the different RPM levels.

In step 1130, an emissions fingerprint is stored by the system. The emissions fingerprint is associated in the system with the particular equipment for which the fingerprint was obtained. In some embodiments, the fingerprint includes a table of different RPM levels and an associated measured emissions output for the particular level (as depicted in FIG. 12).

In step 1140, various pieces of equipment are operated. During the operation of the equipment, the data collection device obtains engine operation time and RPM levels of the operation of the engine. The data collection device transmits the collected operational data to a server.

In step 1150, the system determines an emissions output based on the collected data for a particular piece of equipment. In some embodiments, a machine learning model has been trained to determine an emissions output based on values of operational time a different RPM levels for the equipment. The collected data is input into the trained machine learning model which determines an emissions output for the particular equipment.

The system determines an amount working emissions as compared to non-productive emissions. The system may categorize the emissions into two different groupings of working emissions and idling emissions. The system determines working emissions as the amount of emissions where the equipment is operating at or above a predetermined RPM threshold or values (such as at 1000 RPM). Each piece of equipment may have a different threshold RPM value assigned to it. In some embodiments, the system determines an operation of an engine below a threshold RPM value as being an idle operation of the piece of equipment.

FIG. 12 is a diagram illustrating a chart of measured emissions output for two different vehicles with the same engine make and model. The diagram illustrates an example of two engines of the same type, make and model for vehicles identified as EC1 and EC2. The exhaust of the different vehicles was measured at different RPM engine operation levels. The measured exhaust information is used as the basis for the emissions fingerprint of a particular vehicle. In this example, vehicle EC1 and vehicle EC2 would have two different emissions fingerprints. In some embodiments, measured emissions gases include CO2, CO, O2, excess air NO, NO2, NOx, HC and SO2.

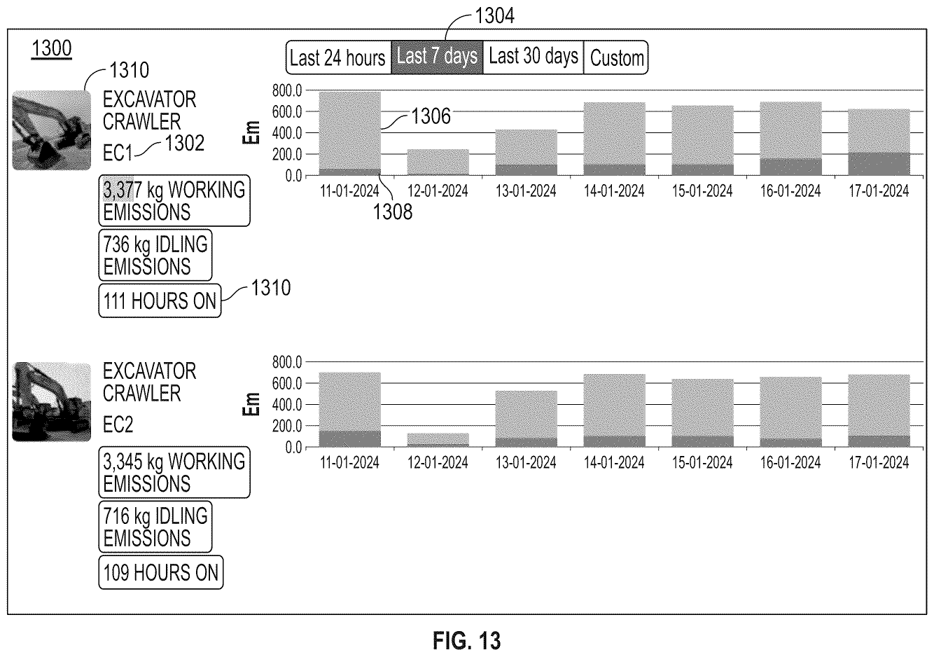

FIG. 13 is a diagram illustrating an exemplary user interface 1300. The system generates user interface 1300 which lists one or more pieces of equipment. The user interface 1300 depicts emissions graphs for respective equipment over a time period 1304. In this example, a time period 1304 (such as the last 7 days) may be selected by a user. In response to the selected time period, the system displays graphs showing emissions of the listed pieces of equipment for a time period. In this example, 7 days of graphs for the pieces of equipment are displayed.

The user interface 1300 may display an image 1310 of a respective piece of equipment and may display the equipment identifier 1302 (e.g., the equipment identifier EC1). Portions of the generated graphs depict a portion of the equipment with working emissions 1306 and idling emissions 1308. A total time of operation 1310 of when the engine is operating (as applicable) may also be displayed.

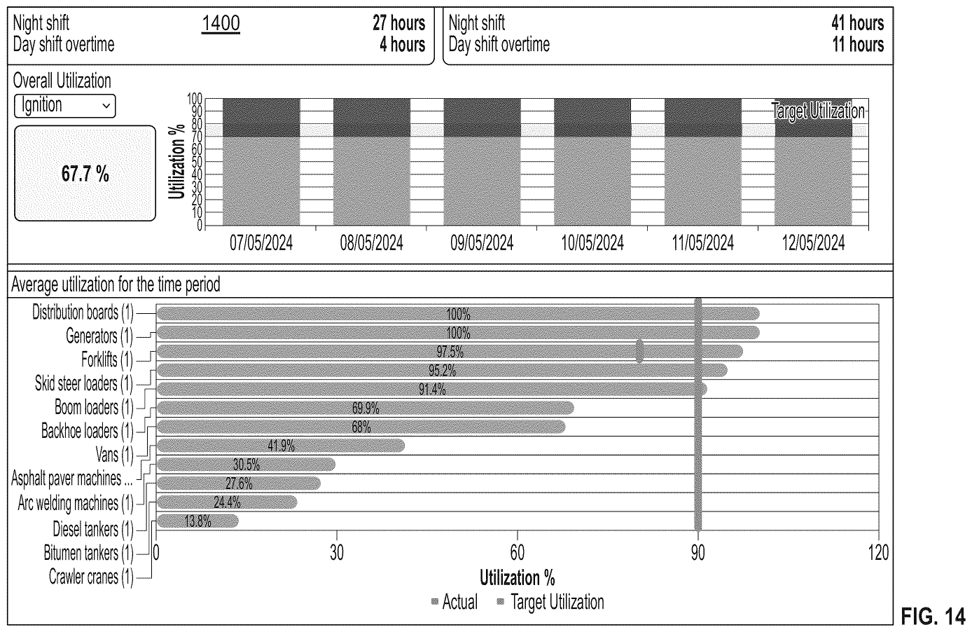

FIG. 14 is a diagram illustrating an exemplary user interface. The system generates user interface 1400 which provides a summary of utilization of multiple pieces of equipment. The user interface 1400 has a portion that depicts an overall utilization percentage. The system may generate an overall utilization percentage overage based on utilization values for the respective multiple pieces of equipment. The user interface 1400 has a portion that depicts for respective time periods (such as a number of days), graphs for aggregate utilization values of the multiple pieces of equipment. The user interface 1400 has a portion that depicts a listing of each of the pieces of the multiple equipment that are part of the overall utilization percentage. The user interface 1400 depicts each of the detailed pieces of equipment with a graph and a percentage value indicating a utilization amount for the particular piece of equipment. The detailed graph may display a targeted utilization rate (such as 90%).

In some embodiments, the system determines an amount of operating time for different day periods. For example, a day may be broken into two or more shifts, such as two 12 hour shifts, or 3 8 hours shifts. Based on the time stamp of the data, the system may determine the shift in which a particular piece of equipment has being utilized.

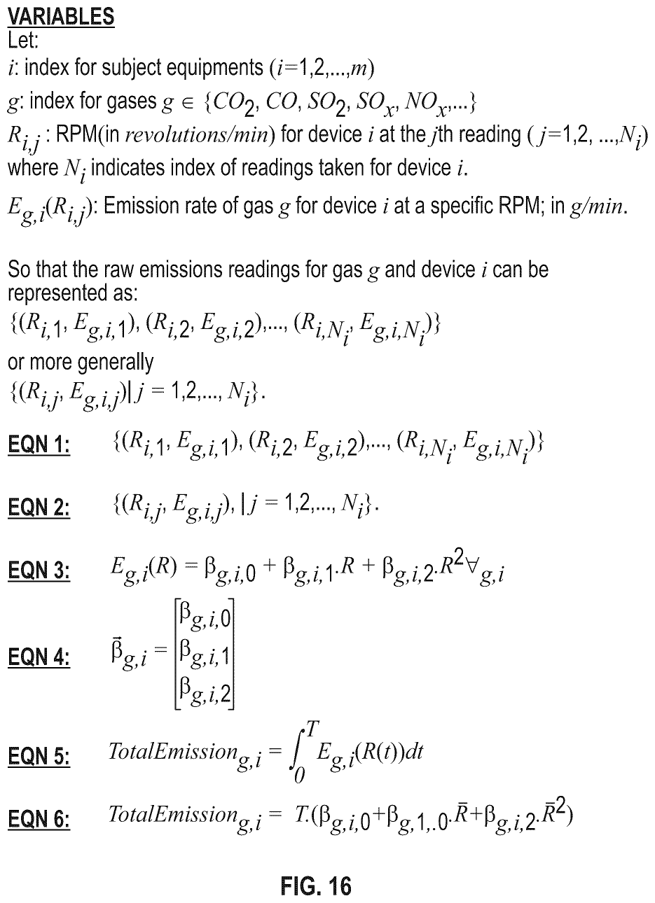

FIG. 16 is a diagram illustrating exemplary equations as to some embodiments related to machine learning for emissions determination. Refer to FIG. 16 for variables and equations as to following discussion regarding determining an emissions fingerprint based on RPM and emissions readings. The raw emissions readings for gas g and device i can be represented as: EQN 1, or more generally as EQN 2. From such emission reading sets, the many quadratic models for each gas g and device i are fitted to profile emission fingerprint of the device. In other words: (see EQN 3), once the system fits the quadratic equation, the system effectively captures (or learns) emission signature of a machine for a specific gas type. In other words, the machine learning model learns such emission signatures from the data. In short, the emission signature can be represented as a vector specific to a machine and gas combination: (See EQN 4). Given we know the emission signature:

→

βg,i, total emission for a gas g and device i over a period of time [0, T] simply becomes: (See EQN 5), or for practical purposes, if we want a discrete approximation of the total emission we can use the following discretized formula with R as the average RPM of the device over the period [0, T]: (See EQN 6). This model allows the system to use just the RPM values for a particular piece of equipment to derive the total emissions for a specific gas since we learn their emission signature.

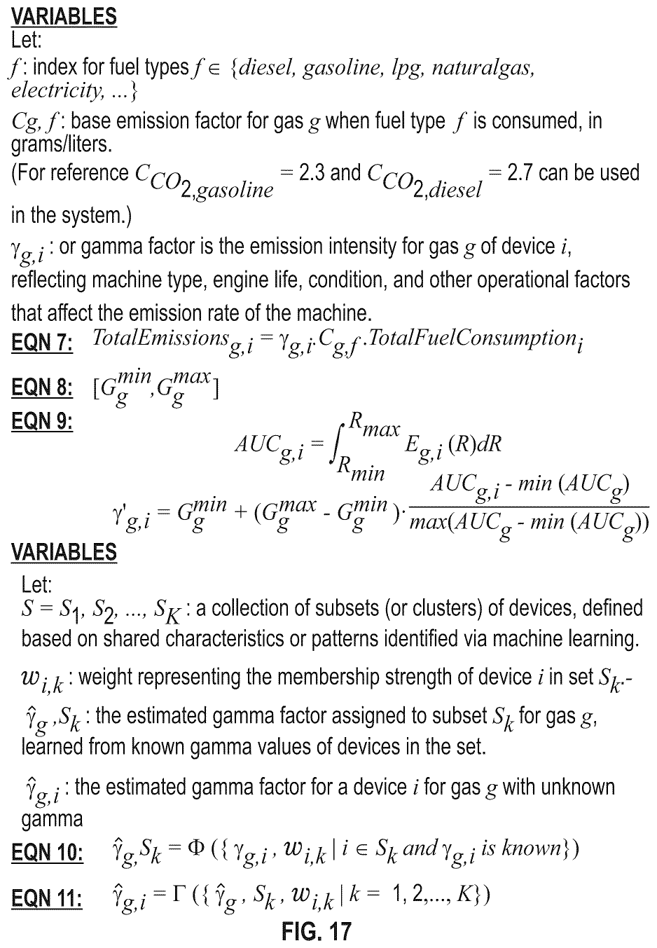

FIG. 17 is a diagram illustrating exemplary equations as to some embodiments related to machine learning for emissions determination. See FIG. 17 for variables and equations as to following discussion regarding determining an emissions output based on fuel consumption of equipment. When the system receives information about fuel consumption for equipment (similar to how the system learns emission signature with respect to RPM), in some embodiments system executes a model and learns emission signature with respect to fuel consumption. The system learns the relationship between fuel consumption and emissions for each gas and subject device. Total emission of gas g for device i, then, can be expressed as: (See EQN7). The gamma factor consolidates the effect of machine-specific and contextual factors on emissions. It is a scalar value learned by the system using the fuel consumption data and the measured emissions; with consideration of base emission factors.

In an alternative approach, the gamma factor is normalized to a closed range between two values. This is established to ensure that the gamma factor is not too sensitive to the fuel consumption data yet still preserves valuable information about the machine's emission intensity. This system does this by utilizing hypothetical and continuous RPM curves representing gas emissions as a function of RPM modeled above. AUC (area and the curve) of each device and gas is calculated first. Then the system uses these AUCs to get a normalized gamma factor (or γ′, or gamma prime) over a gas-specific range (See EQN 8). The process may be simply described with respect to EQN 9. For sake of simplicity in the narrative one may ignore gamma prime and refer to only gamma factor.

Gamma factor is particularly valuable in scenarios where RPM detailed telemetry is unavailable but fuel consumption data or a proxy of fuel consumption is available. However, the system may not obtain individual gamma factors directly in the absence of RPM readings or detailed emission measurements. To be able to derive emissions for such devices, the system generalize gamma factors based on devices' membership in certain sets. Such sets can be defined through shared attributes, operational profiles, outcome of clustering algorithms, or can be more generally defined using many machine learning algorithms.

Then gamma factor estimation for a given set can be defined as a function Φ (set gamma estimator) which could be as simple as an average or weighted average but more generally: (See EQN 10).

So given gamma factor estimates for each set, a function for estimating unknown device-level gamma factors can also be generalized. It can be defined as a function I, which can take various forms but more generally again: (see EQN 11). All in all above approach allows the system to derive emission values for devices via using RPM values or using fuel consumption data and real or estimated gamma factors.

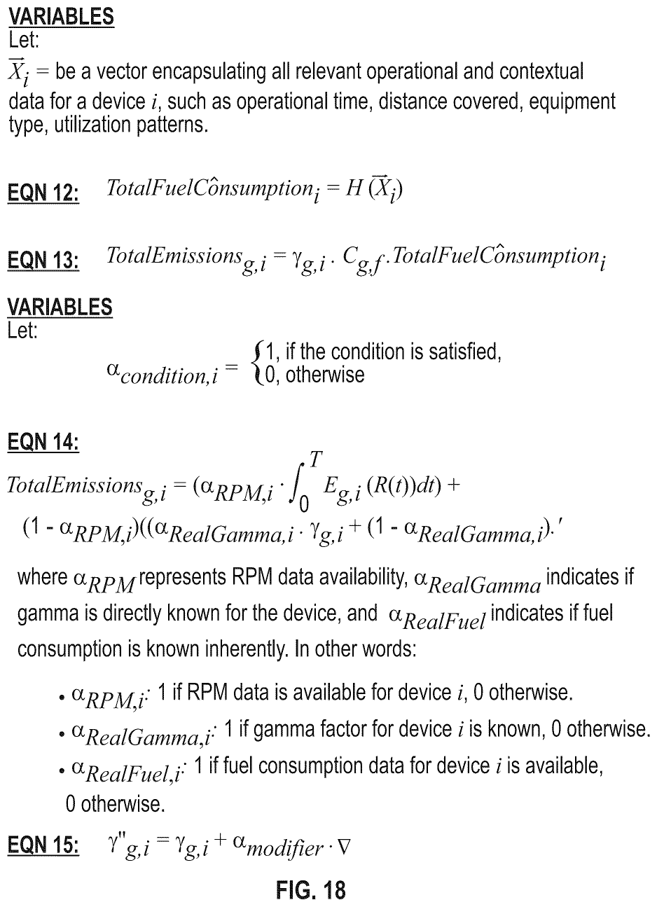

FIG. 18 is a diagram illustrating exemplary equations as to some embodiments related to machine learning for emissions determination. In some embodiments, when actual fuel consumption data is unavailable, the system can use machine learning models to predict fuel consumption and subsequently derive emissions. This approach leverages operational data from the equipment to predict fuel usage and combines it with the emission models previously described (i.e., real or estimated gamma factors along with predicted fuel consumption is used to predict emissions).

In some embodiments, the system performs a model usage determination engine and dynamically selects a machine learning model for usage based on the whether or not the source vehicle or equipment provides RPM values and/or fuel values.

The machine learning model H may be defined as: (See EQN 12), and can be used to predict total emissions satisfying (See EQN 13). In this embodiment, the system selects and executes the machine learning model H, used to predict fuel consumption. The system may utilize approaches including tree-based methods, neural networks, ensemble techniques, probabilistic models, or other classifiers and regressors, selected based on the complexity of the data and the relationships being modeled. The objective of His to optimize a loss function (i.e., to minimize prediction error.)

The system may be configured to deal with or handle sparse data. In some cases, the system receives minimum or sparse data from respective equipment. Since the system may handle various installations with streaming different data points, by design, the system may be configured to handle data sparsity in the machine learning modeling. In some embodiments, the system uses a unified model utilizing the above emissions determination process. For example, the system may use a unified model by revisiting parts of our approach to be able to consolidate all together. (See Second Variables section, FIG. 18 for denoting data, telemetry availability, or generically any condition for a device i.). Since the system may handle several variable in the models (such as RPM-availability, known gammas, known fuel consumption values) our unified model of AI powered emission measurement becomes: (See EQN 14).

The unified model presented elegantly integrates multiple approaches for AI power of measurement of emissions across varying data availability scenarios, ensuring robustness and flexibility. It accommodates sparsity in the data and adapts dynamically to the available information. The unified model can be further expanded with additional conditionalities as the system evolves which is by design allowed thanks to the generalized abstraction presented. One such example may be, but not limited to, redefining gamma as (See EQN 15) depending on the business context or intricacies that might be introduced in the future.

Idling emissions v working emissions—The unified total emissions model provides a holistic AI powered measurement of emissions for a given gas and device over an unspecified time period necessarily (is still [0, T]). However, real-world operations often require state-specific emissions attribution, particularly distinguishing between idling and working over a specified time period. The system my use a state function which determines whether a given time window [t0, t1] is classified as idling or working. It takes as input relevant telemetry or operational parameters (such as but not limited to rpm, movement, power, ignition, load, and data from many other modalities or sensors; with certain thresholds or business logic) for the device and outputs a binary state. Emissions measured using unified model are than mapped to such intervals at any granularities. This provides a clearer understanding of how operational patterns contribute to overall emissions.

Similarly to understand the relation of production volume and emissions, we analyze the relationship between the equipment's output-such as but not limited to the amount of material processed, tasks completed, load carried or distance covered- and the emissions generated during its operation. This involves capturing measurable production metrics, either directly through sensors (like load weights or cycle counts) or indirectly via proxies like load sensor readings or operational duration in working states. Emissions are then attributed to specific production activities by analyzing operational patterns and mapping them to the corresponding production outcomes. By measuring emissions per unit of production (for example, grams of CO2 per ton of material processed), we can identify high-emission activities relative to their output, which may indicate operational inefficiencies.

In some embodiments, the system continuously updates and refines the models described herein, through a continuously learning process of receiving data from the respective vehicles. A vehicle may have a specific model trained for the type of vehicle, vehicle engine, and/or a vehicle model. The system may dynamically select and employ a model to be used with respect to emissions determination based on the type of vehicle, the vehicle engine and/or a vehicle model.

### Additional Examples of Emission Fingerprinting

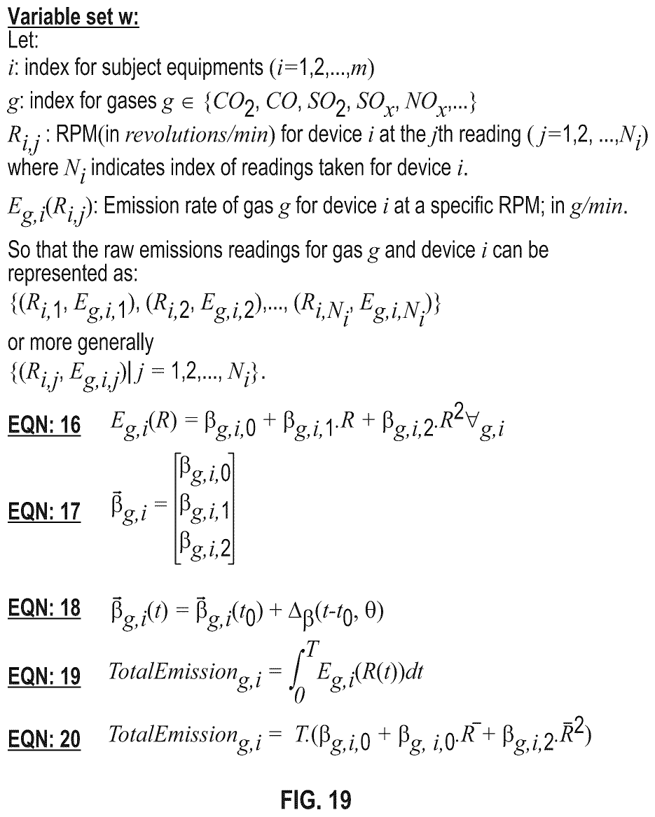

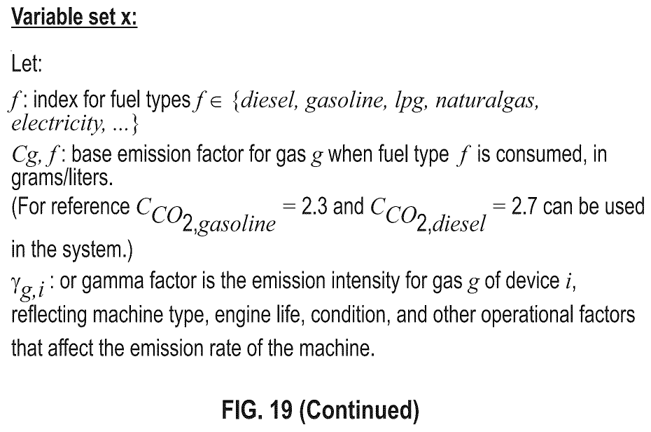

FIGS. 19-21 are diagrams illustrating exemplary equations as to some embodiments related to machine learning for emissions determination as discussed below.

Each piece of equipment may have its own unique emissions fingerprint for different gases. Emissions signature data (or fingerprint) is captured by using emissions reading equipment. The system collects emission readings for different gases along with different RPM (revolutions per minute) operating levels for a fixed period of time. Further details of the subject equipment (such as make, model, idle RPM, engine volume) is also captured before commencing the emission capture. Table 4 describes an example of an emissions fingerprint indicating measured gas output at different engine RPM operating levels.

TABLE 4

| RPM | CO2 | CO | NOx | SO2 |
|---|---|---|---|---|
| 600 | 1.82 | 0 | 295.5 | 0 |
| 1100 | 2.27 | 0 | 328.6 | 0 |
| 1600 | 2.48 | 19 | 317.1 | 0 |
| 2100 | 3.17 | 26 | 239.6 | 0 |

See variable set x in FIG. 19. From such emission reading sets, the many quadratic models for each gas g and device i are fitted to profile emission fingerprint of the device. In other words, see EQN 16.

Once we fit the quadratic equation we effectively capture (or learn) emission signature of the machine for a specific gas. In other words, our machine learning model learns such emission signatures from the data. In short, the emission signature can be represented as a vector specific to a machine and gas combination: see EQN 17.

However, the emission signature β_{g,i} of EQN 17 evolves over equipment's lifetime due to factors including, but not limited to engine wear, combustion efficiency degradation, overall deterioration. So the system models the temporal drift through ML architectures that predict signature evolution between calibration measurements based on the modeled and observed deltas as EQN 18, where Δ_{β} represents the learned drift function and Θ encompasses all relevant operational history between calibration events. ML models including but not limited to ensemble methods, deep learning architectures, and a hybrid of both learn degradation patterns fleet-wide data to identify parameters that influence emission signature changes. Temporal modeling techniques then capture both gradual trends and sudden changes from critical events. Between periodic measurement events, the system continuously updates beta estimates using learned degradation models, maintaining accurate emission signatures without the need of constant recalibration. However whenever new measurements arrive, the system employs online learning to refine the base signatures and drift models while preserving learned patterns.

Given the systems know β_{g,i} of EQN 17 (emission signature at a given point of time) and the system keeps updating it accordingly total emission for a gas g and device i over a period of time [0, T] simply becomes: EQN 19.

Or for practical purposes, if the system wants a discrete approximation of the total emission we can use the following discretized formula with R as the average RPM of the device over the period [0, T] as EQN 20.

The above model lets the system use just the RPM values for a particular piece of equipment to derive the total emissions for a specific gas since we learn their emission signature.

### Emission Signature Based on Fuel Consumption

Whenever the system has information about fuel consumption; similar to how the system learns an emission signature with respect to RPM, the system also models and learns emission signature with respect to fuel consumption. The system learns the relationship between fuel consumption and emissions for each gas and subject device.

See variable set y on FIG. 19. Total emission of gas g for device i, then, can be expressed as EQN 21. The gamma factor consolidates the effect of machine-specific and contextual factors on emissions. It is a scalar value learned by the system using the fuel consumption data and the measured emissions; with consideration of base emission factors.

In an alternative approach, the gamma factor is normalized to a closed range between two values. This is established to ensure that the gamma factor is not too sensitive to the fuel consumption data yet still preserves valuable information about the machine's emission intensity. It is done by utilizing hypothetical and continuous RPM curves representing gas emissions as a function of RPM modeled above. AUC (area and the curve) of each device and gas is calculated first. Then the system uses these AUCs to get a normalized gamma factor (or γ′, or gamma prime) over a gas-specific range as EQN 22. Simply put, see EQN 23.

For sake of simplicity in the narrative we will ignore gamma prime and refer to only gamma factor in the rest of the document.

Gamma factor is particularly valuable in scenarios where RPM detailed telemetry is unavailable but fuel consumption data or a proxy of fuel consumption is available. However, the system cannot obtain individual gamma factors directly in the absence of RPM readings or detailed emission measurements. To be able to derive emissions for such devices, the system may generalize gamma factors based on devices' membership in certain sets. Such sets can be defined through shared attributes, operational profiles, outcome of clustering algorithms, or can be more generally defined using many ML algorithms.

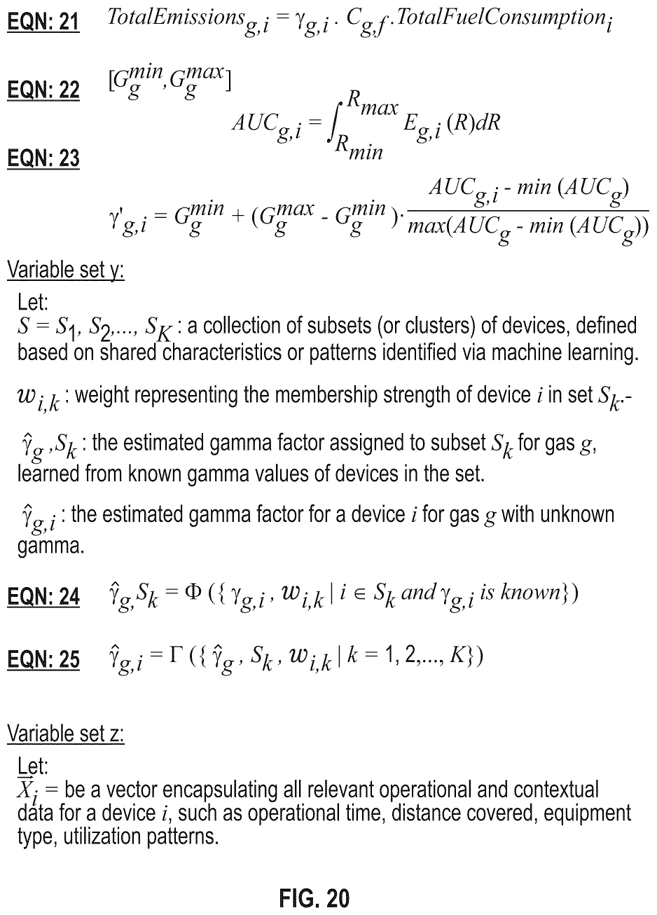

See variable set z in FIG. 20. Then gamma factor estimation for a given set can be defined as a function Φ (set gamma estimator) which could be as simple as an average or weighted average but more generally as EQN 24.

So given gamma factor estimates for each set, a function for estimating unknown device-level gamma factors can also be generalized. It can be defined as a function Γ, which can take various forms but more generally again, as EQN 25.

All in all above approach lets us derive emission values for devices via using RPM values or using fuel consumption data and real or estimated gamma factors.

### Deriving Emissions Using Predicted Fuel Consumption Data

When actual fuel consumption data is unavailable, the system can use machine learning models to predict fuel consumption and subsequently derive emissions. This approach leverages operational data from the equipment to predict fuel usage and combines it with the emission models previously described. In other words, real or estimated gamma factors along with predicted fuel consumption are used to predict emissions.

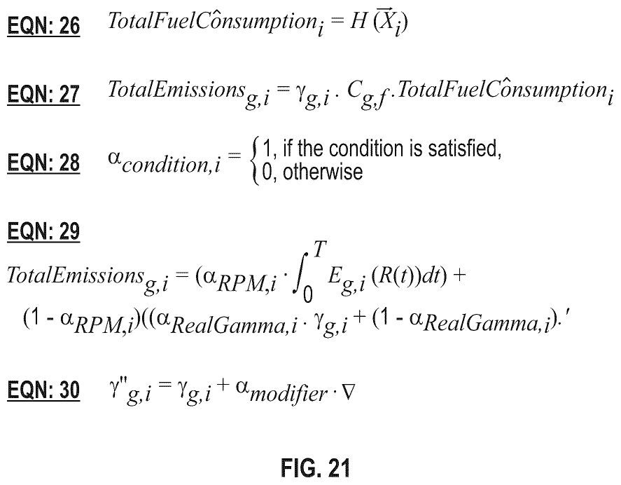

See variable set z in FIG. 20. The ML model H is defined as EQN 26 in FIG. 21, can be used to predict total emissions satisfying EQN 27. The machine learning model H, used to predict fuel consumption, utilizes approaches including tree-based methods, neural networks, ensemble techniques, probabilistic models, and other classifiers and regressors, selected based on the complexity of the data and the relationships being modeled. The objective of His to optimize a loss function and minimize prediction error. The architecture of H employs a two-stream approach for reference: gradient-boosted trees to process categorical and discrete operational features while a series of neural networks capture time dependent patterns in continuous telemetry data. A learned fusion mechanism then incorporates these streams to make its predictions.

Dealing with Sparse Nature of Data

Since the system considers various installations with streaming different data points, by design, the system also deals with sparsity in our modeling. A unified model may be constructed by revisiting parts of the above discussion to be able to consolidate all together.

Let: see EQN 28, for denoting data, telemetry availability, or generically any condition for a device i.

Since several conditions may be used in our models (such as RPM-availability, known gammas, known fuel consumption values) our unified model of AI powered emission measurement becomes EQN 29, where α_{RPM} represents RPM data availability, α_{RealGamma} indicates if gamma is directly known for the device, and α_{RealFuel} indicates if fuel consumption is known inherently. In other words:
α_{RPM,i}: 1 if RPM data is available for device i, 0 otherwise.
α_{RealGamma,i}: 1 if gamma factor for device i is known, 0 otherwise.
α_{RealFuel,i}: 1 if fuel consumption data for device i is available, 0 otherwise.

The unified model presented elegantly integrates multiple approaches for AI powered measurement of emissions across varying data availability scenarios, ensuring robustness and flexibility. It accommodates sparsity in the data and adapts dynamically to the available information. One can further expand the unified model with additional conditionalities as the system evolves which is by design allowed thanks to the generalized abstraction presented.

One such example may be, but not limited to, redefining gamma as EQN 30, depending on the business context or intricacies that might be introduced in the future.

### Deriving Emissions Using Predicted Fuel Consumption

When actual fuel consumption data is unavailable, the system can use machine learning models to predict fuel consumption and subsequently derive emissions. This approach leverages operational data from the equipment to predict fuel usage and combines it with the emission models previously described. I.e. real or estimated gamma factors along with predicted fuel consumption is used to predict emissions.

### Idling Emissions v Working Emissions

The unified total emissions model provides a holistic AI powered measurement of emissions for a given gas and device over an unspecified time period necessarily (is still [0, T]). However, real-world operations often require state-specific emissions attribution, particularly distinguishing between idling and working over a specified time period.

The system defines a state function which determines whether a given time window [t0, t1] is classified as idling or working. State function employs hierarchical ML architectures. The system learns equipment-specific state boundaries through techniques including but not limited to clustering algorithms, classification models with learned kernels, and temporal models capturing state dependencies. Multi-task learning frameworks simultaneously predict operational states and associated emission characteristics, discovering correlations between state signatures and emission profiles. Simply put, it takes as input relevant telemetry or operational parameters (such as but not limited to emissions, rpm, movement, power, ignition, load, and data from many other modalities or sensors; with certain thresholds or business logic; predicted or observed) for the device and outputs a binary state. Emissions measured using the unified model are then mapped to such intervals at any granularities. This provides a clearer understanding of how operational patterns contribute to overall emissions.

Similarly, to understand the relation of production volume and emissions, the system analyzes the relationship between the equipment's output—such as but not limited to the amount of material processed, tasks completed, load carried or distance covered—and the emissions generated during its operation. This involves capturing measurable production metrics, either directly through sensors (like load weights or cycle counts) or indirectly via proxies like load sensor readings or operational duration in working states. Emissions are then attributed to specific production activities by analyzing operational patterns and mapping them to the corresponding production outcomes. By measuring emissions per unit of production (for example, grams of CO2 per ton of material processed), the system can identify high-emission activities relative to their output, which may indicate operational inefficiencies.

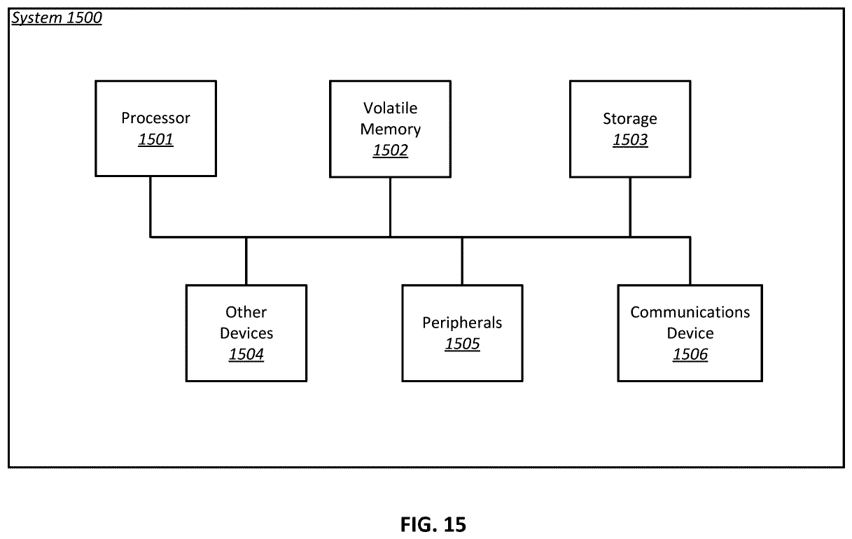

FIG. 15 is a diagram illustrating an exemplary computer that may perform processing in some embodiments. Exemplary computer 1500 may perform operations consistent with some embodiments. The architecture of computer 1500 is exemplary. Computers can be implemented in a variety of other ways. A wide variety of computers can be used in accordance with the embodiments herein.

Processor 1501 may perform computing functions such as running computer programs. The volatile memory 1502 may provide temporary storage of data for the processor 1501. RAM is one kind of volatile memory. Volatile memory typically requires power to maintain its stored information. Storage 1503 provides computer storage for data, instructions, and/or arbitrary information. Non-volatile memory, which can preserve data even when not powered and including disks and flash memory, is an example of storage. Storage 1503 may be organized as a file system, database, or in other ways. Data, instructions, and information may be loaded from storage 1503 into volatile memory 1502 for processing by the processor 1501.

The computer 1500 may include peripherals 1505. Peripherals 1505 may include input peripherals such as a keyboard, mouse, trackball, video camera, microphone, and other input devices. Peripherals 1505 may also include output devices such as a display. Communications device 1506 may connect the computer 1500 to an external medium. For example, communications device 1506 may take the form of a network adapter that provides communications to a network. A computer 1500 may also include a variety of other devices 1504. The various components of the computer 1500 may be connected by a connection medium such as a bus, crossbar, or network.

It will be appreciated that the present disclosure may include any one and up to all of the following examples.

Example 1: A system for monitoring operations of equipment, comprising: one or more data collection devices, each comprising: an onboard processor; storage device; and a transmitter; one or more pressure sensors connected to hydraulic lines of the vehicle; wherein the processor is configured to perform the operations of: obtaining pressure readings from the one or more pressure sensors; obtaining vehicle operation information from the vehicle, the vehicle operation information including RPM values of the engine of the vehicle; storing on the storage device collected vehicle data comprising the pressure readings and the vehicle operation information; and transmitting the collected vehicle data to one or more servers; and the one or more servers comprising: one or more server processors; and server storage; wherein the one or more server processors are configured to perform the operations of: assigning an identifier and a vehicle type to a plurality of vehicles; receiving the collected vehicle data; selecting a metric to be applied to the received vehicle data; applying the selected metric to the collected vehicle data and determining utilization of the vehicle; generating a graph associated with the collected vehicle data, the graph depicting utilization of the vehicle for a time period; and providing for display, via a user interface, the generated graph.

Example 2. The system of Example 1, the operations of the server further comprising: wherein the collected vehicle data comprises one or more images depicting a component of the vehicle in proximity with another vehicle; and depicting one of the one or more images via the user interface.

Example 3. The system of any one of Examples 1-2, wherein the collected vehicle data comprises RPM values of the vehicle and hydraulic pressures from the vehicle.

Example 4. The system of any one of Examples 1-3, the operations of the server further comprising: receiving, by the server a first set of sensor data from a first data collection device installed on a first vehicle, wherein the first vehicle is of a first assigned vehicle type; receiving, by the server sensor a second set of sensor data from a second data collection device installed on a second vehicle, wherein the second vehicle of a second assigned vehicle type, the first assigned vehicle type being different than the second assigned vehicle type; generating a first graph by applying a first metric to the first set of sensor data, the first metric selected based on the first assigned vehicle type; and generating a second graph by applying a second metric to the second set of sensor data, the second metric selected based on the second assigned vehicle type.

Example 5. The system of any one of Examples 1-4, the one or more data collection devices, each further comprising: a location determination device comprising a global positioning satellite receiver; wherein the processor is further configured to perform the operations of: storing on the storage device a plurality of location coordinates and time stamps of the vehicle during operations of the engine of the vehicle.

Example 6. The system of any one of Examples 1-5, further comprising: a computer vision system comprising one or more cameras affixed to the vehicle; wherein the processor is further configured to perform the operations of: obtaining a plurality of images via the one or more cameras; storing on the storage device the plurality of images; and evaluating the images to determine the occurrence of another vehicle in the one or more images.

Example 7. The system of any one of Examples 1-6, wherein the one or more servers perform the operation comprising: assigning a vehicle type for each of a plurality of vehicles; receiving vehicle operation information for each of the plurality of vehicles, wherein the vehicle operation information includes RPM values of the engine of a respective vehicle; and receiving pressure readings for each of the plurality of vehicles from the one or more pressure sensors; determining based on the vehicle type and the received vehicle operation information and the received pressure readings, a utilization indication for each of the plurality of vehicles; and providing for display, via a user interface, the utilization indication for each of the plurality of vehicles, wherein the plurality of vehicles includes at least two vehicles assigned to two different vehicles.

Example 8. The system of any one of Examples 1-7, applying the selected metric to the collected vehicle data comprises: determining a utilization indication by: evaluating values for the pressure readings of a particular vehicle where the pressure readings are within a range of predetermined values and identifying the vehicle as being utilized.

Example 9. The system of any one of Examples 1-8, wherein the utilization indication is determined by also evaluating location values for the particular vehicle, where the location values indicate the particular vehicle is moving.

Example 10. The system of any one of Examples 1-9, wherein the utilization indication is determined by also evaluating RPM values for the particular vehicle.

Example 11. The system of any one of Examples 1-10, wherein the one or more servers further perform the operations comprising: obtaining a first emissions fingerprint for each of the multiple vehicles, wherein the fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPMs in reference to the first emissions fingerprint.

Example 12. The system of any one of Examples 1-11, wherein the one or more servers further perform the operations comprising: obtaining a second emissions fingerprint for each of the multiple vehicles, wherein the second emissions fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPMs in reference to the second emissions fingerprint.

Example 13. A method of monitoring the operations of a plurality of pieces of equipment, the method comprising: obtaining pressure readings from the one or more pressure sensors installed on a vehicle; obtaining vehicle operation information from a vehicle, the vehicle operation information including RPM values of the engine of the vehicle; storing on the a data collection device, the collected vehicle data comprising the pressure readings and the vehicle operation information; and transmitting, from the data collection device, the collected vehicle data to one or more servers; assigning an identifier and a vehicle type to a plurality of vehicles; receiving, via one or more servers, the collected vehicle data; selecting a metric to be applied to the received vehicle data; applying, by the one or more servers, the selected metric to the collected vehicle data and determining utilization of the vehicle; generating a graph associated with the collected vehicle data, the graph depicting utilization of the vehicle for a time period; and providing for display, via a user interface, the generated graph.

Example 14. The method of Example 13, further comprising the operations of: wherein the collected vehicle data comprises one or more images depicting a component of the vehicle in proximity with another vehicle; and depicting one of the one or more images via the user interface.

Example 15. The method of any one of Examples 12-14, wherein the collected vehicle data comprises RPM values of the vehicle and hydraulic pressures from the vehicle.

Example 16. The method of any one of Examples 12-15, further comprising the operations of: receiving, by the server a first set of sensor data from a first data collection device installed on a first vehicle, wherein the first vehicle is of a first assigned vehicle type; receiving, by the server sensor a second set of sensor data from a second data collection device installed on a second vehicle, wherein the second vehicle of a second assigned vehicle type, the first assigned vehicle type being different than the second assigned vehicle type; generating a first graph by applying a first metric to the first set of sensor data, the first metric selected based on the first assigned vehicle type; and generating a second graph by applying a second metric to the second set of sensor data, the second metric selected based on the second assigned vehicle type.

Example 17. The method of any one of Examples 12-16, further comprising: storing on the storage device a plurality of location coordinates and time stamps of the vehicle during operations of the engine of the vehicle.

Example 18. The method of any one of Examples 12-17, further comprising the operations of: obtaining a plurality of images via the one or more cameras; storing on the storage device the plurality of images; and evaluating the images to determine the occurrence of another vehicle in the one or more images.

Example 19. The method of any one of Examples 12-18, further comprising the operations of: assigning a vehicle type for each of a plurality of vehicles; receiving vehicle operation information for each of the plurality of vehicles, wherein the vehicle operation information includes RPM values of the engine of a respective vehicle; and receiving pressure readings for each of the plurality of vehicles from the one or more pressure sensors; determining based on the vehicle type and the received vehicle operation information and the received pressure readings, a utilization indication for each of the plurality of vehicles; and providing for display, via a user interface, the utilization indication for each of the plurality of vehicles, wherein the plurality of vehicles includes at least two vehicles assigned to two different vehicles.

Example 20. The method of any one of Examples 12-19, further comprising the operations of: applying a selected metric to the collected vehicle data comprising the operations of: determining a utilization indication by: evaluating values for the pressure readings of a particular vehicle where the pressure readings are within a range of predetermined values and identifying the vehicle as being utilized.

Example 21. The method of any one of Examples 12-20, wherein the utilization indication is determined by also evaluating location values for the particular vehicle, where the location values indicate the particular vehicle is moving.

Example 22. The method of any one of Examples 12-21, wherein the utilization indication is determined by also evaluating RPM values for the particular vehicle.

Example 23. The method of any one of Examples 12-22, further comprising the operations of: obtaining a first emissions fingerprint for each of the multiple vehicles, wherein the fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPMs in reference to the first emissions fingerprint.

Example 24. The method of any one of Examples 12-23, further comprising the operations of: obtaining a second emissions fingerprint for each of the multiple vehicles, wherein the second emissions fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPMs in reference to the second emissions fingerprint.

Example 25. A system for monitoring operations of equipment, comprising: one or more data collection devices, each comprising: an onboard processor; storage device; and a transmitter; wherein the processor is configured to perform the operations of: obtaining equipment operation information from the equipment, the equipment operation information including RPM values of the engine of the equipment; storing on the storage device collected equipment operational data comprising the equipment operation information; and transmitting the collected equipment operational data to one or more servers; and the one or more servers comprising: one or more server and processors; server storage; wherein the one or more server processors are configured to perform the operations of: receiving the equipment operational data; determining an estimated emissions output for the equipment; generating a graph associated depicting an emissions output of the equipment for a time period; and providing for display, via a user interface, the generated graph.

Example 26. The system of Example 25, wherein the one or more servers perform the operations comprising: assigning an emissions fingerprint to a particular equipment.

Example 27. The system of any one of Examples 25-26, wherein the emissions fingerprint includes emissions gases for one or more of CO₂, CO, O2, excess air NO, NO2, NOx, HC and SO2.

Example 28. The system of any one of Examples 25-27, determining based on the equipment operational data and the assigned emissions fingerprint, the estimated emission output.

Example 29. The system of any one of Examples 25-28, wherein the equipment has a first emissions fingerprint assigned to it, and a different second emissions fingerprint is assigned to another equipment.

Example 30. The system of any one of Examples 25-29, wherein the one or more servers further perform the operations comprising: obtaining a first emissions fingerprint for each of the multiple vehicles, wherein the fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPM values in reference to the first emissions fingerprint.

Example 31. The system of any one of Examples 25-30, wherein the one or more servers further perform the operations comprising: obtaining a second emissions fingerprint for each of the multiple vehicles, wherein the second emissions fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPM values in reference to the second emissions fingerprint.

Example 32. The system of any one of Examples 25-31, wherein the received the equipment operational data is input into a trained machine learning model to determine the estimated emissions output for the equipment.

Example 33. The system of any one of Examples 25-32, wherein the assigned emissions fingerprint for the particular equipment is replaced with another assigned emissions fingerprint.

Example 34. The system of any one of Examples 25-33, wherein the user interface depicts multiple equipment each with a graph depicting an amount of estimated emission for a respective equipment, and a value for an amount of working emission and a value for an amount of idling emissions.

Example 35. A method for monitoring operations of equipment, comprising: obtaining equipment operation information from the equipment, the equipment operation information including RPM values of the engine of the equipment; storing on the storage device collected equipment operational data comprising the equipment operation information; and transmitting the collected equipment operational data to one or more servers; and receiving, via the server, the equipment operational data; determining an estimated emissions output for the equipment;

generating a graph associated depicting an emissions output of the equipment for a time period;

and providing for display, via a user interface, the generated graph.

Example 36. The method of Example 35, further comprising the operations of: assigning an emissions fingerprint to a particular equipment.

Example 37. The method of any one of Examples 35-36, wherein the emissions fingerprint includes emissions gases for one or more of CO₂, CO, O2, excess air NO, NO2, NOx, HC and SO2.

Example 38. The method of any one of Examples 35-37, wherein the estimated emission output is determined based on the equipment operational data and the assigned emissions fingerprint.

Example 39. The method of any one of Examples 35-38, wherein the equipment has a first emissions fingerprint assigned to it, and a different second emissions fingerprint is assigned to another equipment.

Example 40. The method of any one of Examples 35-39, further comprising the operations of: obtaining a first emissions fingerprint for each of the multiple vehicles, wherein the fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPM values in reference to the first emissions fingerprint.

Example 41. The method of any one of Examples 35-40, wherein the one or more servers further perform the operations comprising: obtaining a second emissions fingerprint for each of the multiple vehicles, wherein the second emissions fingerprint comprises values for gas emission produced at multiple different RPM levels of an engine of a respective vehicle; and determining an emissions output for each of the multiple vehicles, wherein the emissions output is calculated based on the duration of the operation of a particular vehicle at the multiple different RPM values in reference to the second emissions fingerprint.

Example 42. The method of any one of Examples 35-41, wherein the received the equipment operational data is input into a trained machine learning model to determine the estimated emissions output for the equipment.

Example 43. The method of any one of Examples 35-42, wherein the assigned emissions fingerprint for the particular equipment is replaced with another assigned emissions fingerprint.

Example 44. The method of any one of Examples 35-43, wherein the user interface depicts multiple equipment each with a graph depicting an amount of estimated emission for a respective equipment, and a value for an amount of working emission and a value for an amount of idling emissions.

Example 45. A system for monitoring operations of a vehicle, comprising: one or more data collection devices, each comprising: an onboard processor; storage device; and a transmitter; one or more camera attached to the vehicle; wherein the processor is configured to perform the operations of: obtaining a plurality of images from the one or more camera depicting an operation of a component of the vehicle; storing on the storage device the plurality of images; and transmitting the collected vehicle data to one or more servers; and the one or more servers comprising: one or more server processors; and server storage; wherein the one or more server processors are configured to perform the operations of: determining, based on the plurality of images, a utilization of the vehicle.

Example 46. The system of Example 45, wherein the determining the utilization comprises determining a cycle count for a movement of the component from a loading area to an unloading area.

Example 46. The system of Example 45, wherein the determining the utilization comprises determining whether another object is depicted in an image, the object being detected is a portion of a dump truck.

Example 47. The system of any one of examples 45-46, further comprising: generating and displaying a graph depicting the utilization of the vehicle

Example 48. A system for monitoring operations of equipment, comprising: one or more data collection devices, each comprising: an onboard processor; storage device; and a transmitter; one or more sensors attached to the equipment; wherein the processor is configured to perform the operations of: obtaining information that the equipment is turned on and/or running, and sensor data that the equipment is being used; storing on the storage device the information; and transmitting the information to one or more servers; and the one or more servers comprising: one or more server processors; and server storage; wherein the one or more server processors are configured to perform the operations of: determining, based on the received information, a utilization of the equipment.

Example 49. The system of any one of examples 48, further comprising: generating and displaying a graph depicting the utilization of the equipment depicting a time period that the equipment is on or running, and a time period indicating that the equipment is being used.

Some portions of the preceding detailed descriptions have been presented in terms of algorithms, equations and/or symbolic representations of operations on data bits within a computer memory. These algorithmic and/or equation descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems is used with programs in accordance with the teachings herein, or it may prove convenient to construct a more specialized apparatus to perform the method. The structure for a variety of these systems will appear as set forth in the description above. In addition, the present disclosure is not described with reference to any programming language. It will be appreciated that a variety of programming languages is used to implement the teachings of the disclosure as described herein.

The present disclosure may be provided as a computer program product, or software, that may include a machine-readable medium having stored thereon instructions, which is used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A system for monitoring operations of a multiple pieces of equipment each having a different equipment type, the system comprising:
one or more data collection devices, each comprising:
an onboard processor;
storage device; and
a transmitter;
one or more sensors to a piece of equipment;
wherein the processor is configured to perform the operations of:
obtaining sensor readings from the one or more sensors;
storing on the storage device collected sensor data comprising the sensor readings; and
transmitting the collected sensor data to one or more servers; and
the one or more servers comprising:
one or more server processors; and
server storage;
wherein the one or more server processors are configured to:
assign an identifier and an equipment type to each of the multiple pieces of equipment;
receive the sensor data from at least a first data collection device installed on a first piece of equipment and from a second data collection device installed on a second piece of equipment;
apply a first utilization metric to be applied to the sensor data received from the first data collection device, wherein the first utilization metric is selected based on an equipment type of the first piece of equipment;
apply a second utilization metric to be applied to the sensor data received from the second data collection device, wherein the second utilization metric is selected based an equipment type of the second piece of equipment, wherein the first type and the second type of equipment are different types; and
based on the applied first utilization metric and the applied second utilization metric, generate a user interface, depicting utilization graphs for each of the multiple pieces of equipment.

2. The system of claim 1, the operations of the server further comprising:
wherein the received sensor data comprises one or more images depicting a component of the equipment in proximity with another piece of equipment; and
depicting one of the one or more images via the user interface.

3. The system of claim 1, wherein the received equipment data comprises RPM values of an engine of the first piece of equipment and hydraulic pressures for the first piece of equipment.

4. The system of claim 1, the operations of the server further comprising:
generating a first graph by applying a first metric to the first set of sensor data, the first metric selected based on the first assigned vehicle type;
generating a second graph by applying a second metric to the second set of sensor data, the second metric selected based on the second assigned vehicle type; and
providing for display, the first and second graph, via the user interface.

5. The system of claim 1, the one or more data collection devices, each further comprising:
a location determination device comprising a global positioning satellite receiver;
wherein the processor of the data collection device is further configured to:
store a plurality of location coordinates and time stamps of the equipment during operations of an engine of the equipment.

6. The system of claim 1, further comprising:
a computer vision system comprising one or more cameras affixed to the equipment;
wherein the one or more server processors are further configured:
evaluate the images obtained from the computer visions system to determine the occurrence of whether another piece of equipment in displayed the one or more images.

7. The system of claim 1, the one or more server processors are further configured to:
receive equipment operation information for each of first pieces of equipment, wherein the equipment operation information includes RPM values of an engine of the first piece of equipment; and
determine based on the equipment type, the received equipment operation information and the received pressure readings, a utilization indication for the first piece of equipment; and
providing for display, via a user interface, the utilization indication for the first piece of equipment.

8. The system of claim 1, applying the selected metric comprises:
evaluating values for the pressure readings of the first piece of equipment where the pressure readings are within a range of predetermined values and identifying the first piece of equipment as being utilized.

9. The system of claim 1, where the one or more server processors are further configured to:
determine an aggregate utilization value for the multiple pieces of equipment; and
provide for display, via a user interface, a listing of the multiple pieces of equipment and the aggregate utilization value.

10. The system of claim 1, applying the first utilization metric comprises any one of the following:
determining whether the received sensor data from the first data collection device indicates that hydraulics of the equipment were activated;
determining whether the received sensor data from the first data collection device indicates that an auger was activated;
determining whether the received sensor data from the first data collection device indicates that a sprayer was activated;
determining whether the received sensor data from the first data collection device indicates that a blade was activated; and
determining whether the received sensor data from the first data collection device indicates that a boom was activated.

11. A method of monitoring operations of a multiple pieces of equipment each having a different equipment type, the method comprising assigning an identifier and an equipment type to each of the multiple pieces of equipment;
receiving sensor data from at least a first data collection device installed on a first piece of equipment and from a second data collection device installed on a second piece of equipment;
applying a first utilization metric to be applied to the sensor data received from the first data collection device, wherein the first utilization metric is selected based on an equipment type of the first piece of equipment;
applying a second utilization metric to be applied to the sensor data received from the second data collection device, wherein the second utilization metric is selected based an equipment type of the second piece of equipment, wherein the first type and the second type of equipment are different types; and
based on the applied first utilization metric and the applied second utilization metric, generating a user interface, depicting utilization graphs for each of the multiple pieces of equipment.

12. The method of claim 11, the operations of the server further comprising:
wherein the received sensor data comprises one or more images depicting a component of the equipment in proximity with another piece of equipment; and
depicting one of the one or more images via the user interface.

13. The method of claim 11, wherein the received equipment data comprises RPM values of an engine of the first piece of equipment and hydraulic pressures for the first piece of equipment.

14. The method of claim 11, the operations of the server further comprising:
generating a first graph by applying a first metric to the first set of sensor data, the first metric selected based on the first assigned vehicle type;
generating a second graph by applying a second metric to the second set of sensor data, the second metric selected based on the second assigned vehicle type; and
providing for display, the first and second graph, via the user interface.

15. The method of claim 11, the one or more data collection devices, each further comprising:
a location determination device comprising a global positioning satellite receiver;
wherein the processor of the data collection device is further configured to:
store a plurality of location coordinates and time stamps of the equipment during operations of an engine of the equipment.

16. The system of claim 11, further comprising:
evaluating the images obtained from a computer visions system installed on the first piece of equipment to determine the occurrence of whether another piece of equipment in displayed in one or more images.

17. The method of claim 11, the one or more server processors are further configured to:
receiving equipment operation information for the first piece of equipment, wherein the equipment operation information includes RPM values of an engine of the first piece of equipment; and
determining based on the equipment type, the received equipment operation information and the received pressure readings, a utilization indication for the first piece of equipment; and
providing for display, via a user interface, the utilization indication for the first piece of equipment.

18. The method of claim 11, applying the selected metric comprises:
evaluating values for the pressure readings of the first piece of equipment where the pressure readings are within a range of predetermined values and identifying the first piece of equipment as being utilized.

19. The method of claim 11, applying the first utilization metric comprises:
determining an aggregate utilization value for the multiple pieces of equipment; and
providing for display, via a user interface, a listing of the multiple pieces of equipment and the aggregate utilization value.

20. The method of claim 11, applying the first utilization metric comprises any one of the following:
determining whether the received sensor data from the first data collection device indicates that hydraulics of the equipment were activated;
determining whether the received sensor data from the first data collection device indicates that an auger was activated;
determining whether the received sensor data from the first data collection device indicates that a sprayer was activated;
determining whether the received sensor data from the first data collection device indicates that a blade was activated; and
determining whether the received sensor data from the first data collection device indicates that a boom was activated.
